(19) United States
(12) Patent Application Publication
(10) Pub. No.: US 2026/0178972 A1
(43) Pub. Date: Jun. 25, 2026

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventors: Ryo HASEGAWA, Kanagawa (JP); Tian NIE, Kanagawa (JP); Masato ANDO, Kanagawa (JP)

(73) Assignee: FUJIFILM Business Innovation Corp., Tokyo (JP)

(21) Appl. No.: 19/187,246

(22) Filed: Apr. 23, 2025

(30) Foreign Application Priority Data
Dec. 25, 2024 (JP) 2024-229316

(51) Int. Cl. G06N 20/00

(52) U.S. Cl. CPC G06N 20/00

(57) ABSTRACT

An information processing system includes a processor configured to: accept, as a piece of teacher data, a piece of first table data and a piece of second table data between which results of matching indicate correctness; combine each of pieces of first column data in the piece of first table data and each of pieces of second column data in the piece of second table data, the each of the pieces of first column data and the each of the pieces of second column data being identical to each other in data type, to generate a piece of second teacher data; and use a model having undergone learning, the model being generated from the piece of second teacher data, to present candidates for associating each of the pieces of first column data and each of the pieces of second column data with each other.

### CROSS-REFERENCE TO RELATED APPLICATIONS

This application is based on and claims priority under 35 USC 119 from Japanese Patent Application No. 2024-229316 filed Dec. 25, 2024.

### BACKGROUND

### (i) Technical Field

The present disclosure relates to an information processing system and a non-transitory computer readable medium.

### (ii) Related Art

Nowadays, there are services that utilize information technology (IT) to support business. For example, there is a service that utilizes a model that has undergone machine learning (hereinafter referred to as a “model having undergone learning”) to support business of a user. To provide a highly accurate service, however, it is necessary to generate a special model having undergone learning, which is dedicated to content of business of the user.

Patent Document 1: Japanese Unexamined Patent Application Publication (Translation of PCT Application) No. 2023-534475

### SUMMARY

To generate a model having undergone learning for matching of two pieces of table data that differ from each other in format, for example, it is necessary to select data columns to be used for learning. For example, the user manually selects a correspondence relationship to be used for learning from the two pieces of table data. On the other hand, there is also a scheme that verifies, for all data columns in the two pieces of table data, and presents, to the user, combination candidates. When this scheme is employed, however, there is an increased period of time for pre-processing to be executed before reaching a final goal, that is, before generating a model having undergone learning.

Aspects of non-limiting embodiments of the present disclosure relate to shortening of a period of time required for pre-processing, compared with a case where a correspondence relationship with which a degree of accuracy of prediction of correctness and incorrectness is increased is verified for all data columns in two pieces of table data that differ from each other in format.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: accept, as a piece of teacher data, a piece of first table data and a piece of second table data between which results of matching indicate correctness; combine each of pieces of first column data in the piece of first table data and each of pieces of second column data in the piece of second table data, the each of the pieces of first column data and the each of the pieces of second column data being identical to each other in data type, to generate a piece of second teacher data; and use a model having undergone learning, the model being generated from the piece of second teacher data, to present candidates for associating each of the pieces of first column data and each of the pieces of second column data with each other.

### BRIEF DESCRIPTION OF THE DRAWINGS

An exemplary embodiment of the present disclosure will be described in detail based on the following figures, wherein:

FIG. 1 is a diagram illustrating an example of a business support system assumed in the exemplary embodiment;

FIG. 2 is a diagram illustrating an example of a hardware configuration of a business support server;

FIG. 3 is a diagram illustrating a deleting operation due to depositing of money;

FIG. 4 is a diagram illustrating an example of a matching operation;

FIG. 5 is a diagram illustrating a data type for each piece of column data in teacher data of correctness;

FIG. 6 is a diagram illustrating a data example of teacher data of correctness;

FIG. 7 is a diagram illustrating uploading of teacher data of correctness from a user terminal to the business support server;

FIG. 8 is a diagram illustrating a pre-processing example for generating a model having undergone learning;

FIG. 9 is a diagram illustrating a data example of teacher data of correctness and incorrectness;

FIG. 10 is a diagram illustrating classification of column data by data type;

FIG. 11 is a diagram illustrating a specific example of pieces of teacher data of correctness and incorrectness, each for each data type;

FIG. 12 is a diagram illustrating generation processing for a combination of pieces of column data in unit of data type;

FIG. 13 is a diagram illustrating combination examples of data columns each for each data type;

FIG. 14 is a diagram illustrating pieces of teacher data of correctness and incorrectness respectively corresponding to combinations of data columns prepared each for each data type;

FIG. 15 is a diagram illustrating generation processing for teacher data for learning;

FIG. 16 is a diagram illustrating an example of teacher data for learning, in which a feature amount is designated for each combination;

FIG. 17 is a diagram illustrating a generation example of pieces of teacher data for learning, each of which corresponds to a combination;

FIG. 18 is a diagram illustrating generation processing for a model having undergone learning;

FIG. 19 is a diagram illustrating evaluation processing for models having undergone learning, which are each generated for each combination of pieces of column data;

FIG. 20 is a diagram illustrating an example of scores corresponding to models having undergone learning;

FIG. 21 is a sequence diagram illustrating an example of providing the business support service;

FIG. 22 is a diagram illustrating a display example of a designation acceptance screen for targets for matching, which is to be displayed on a user terminal;

FIG. 23 is a diagram illustrating another display example of the designation acceptance screen for targets for matching;

FIG. 24 is a diagram illustrating still another display example of the designation acceptance screen for targets for matching;

FIG. 25 is a sequence diagram illustrating another example of providing the business support service;

FIG. 26 is a diagram illustrating a display example of the designation acceptance screen for targets for matching, which is to be displayed on the user terminal;

FIG. 27 is a diagram illustrating a change of screen, which corresponds to steps 122 and 123;

FIG. 28 is a sequence diagram illustrating still another example of providing the business support service;

FIG. 29 is a diagram illustrating switching of screen along with a screen operation by the user;

FIG. 30 is a sequence diagram illustrating still another example of providing the business support service; and

FIG. 31 is a diagram illustrating a display example of the designation acceptance screen for targets for matching.

### DETAILED DESCRIPTION

An exemplary embodiment of the present disclosure will now be described herein with reference to the accompanying drawings.

### Exemplary Embodiment

### <System Configuration>

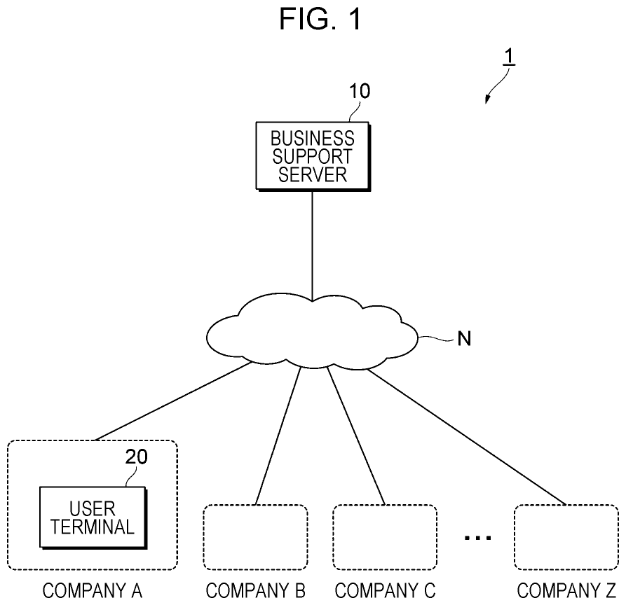

FIG. 1 is a diagram illustrating an example of a business support system 1 according to the exemplary embodiment. The business support system 1 illustrated in FIG. 1 includes a business support server 10 and a user terminal 20.

Incidentally, the user terminal 20 is a terminal operated by a user in charge in a company that receives provision of a business support service.

Although there are a plurality of companies that utilize the business support service in the case illustrated in FIG. 1, there may be only one company. The user terminal 20 is solely illustrated in a company A illustrated in FIG. 1. However, the company A may have a plurality of the user terminals 20. Furthermore, a number of the user terminals 20 may differ for each of the companies.

The business support server 10 is a server that provides the business support service. Although the business support server 10 is solely illustrated in FIG. 1, there may be a plurality of the business support servers 10. Furthermore, the business support service may be provided through cooperation of the plurality of business support servers 10. The plurality of business support servers 10 that cooperate with each other cooperate with each other via a network N, for example. However, as to the network N used by the plurality of business support servers 10 that cooperate with each other, there may be a network that differs from the network N used by the plurality of business support servers 10 for coupling with the user terminals 20.

As the user terminal 20, a desktop computer, a notebook computer, a tablet computer, or a smartphone, for example, is used.

The network N may be, for example, the Internet, a local area network (LAN), or a mobile communication system conforming to 4G, 5G, or another standard. The network N may be a wired network, a wireless network, or a wired-and-wireless-mixed network.

### <Hardware Configuration of Business Support Server>

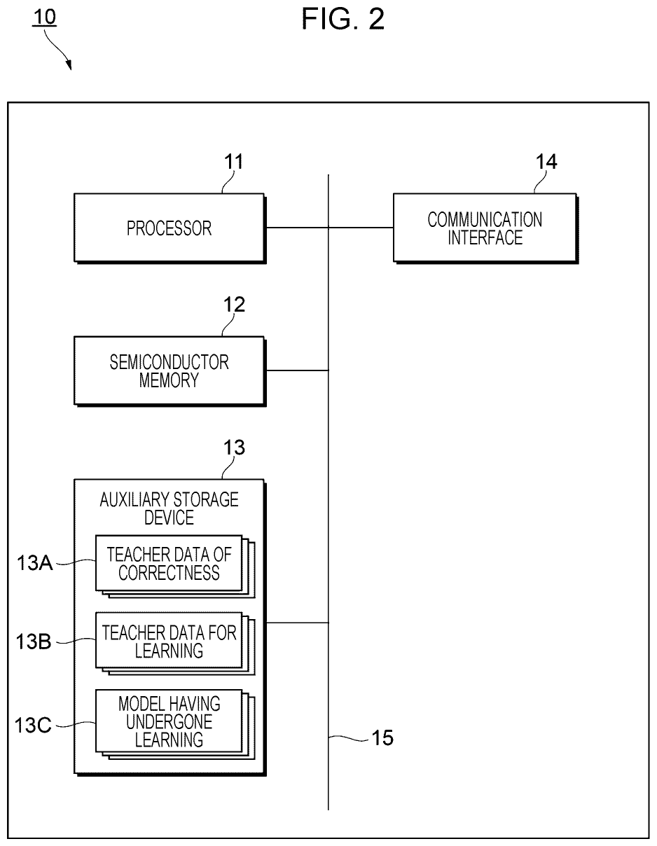

FIG. 2 is a diagram illustrating an example of a hardware configuration of the business support server 10. The business support server 10 referred herein is an example of an information processing system. Note that the business support system 1 (see FIG. 1) may be regarded as an example of the information processing system.

The business support server 10 illustrated in FIG. 2 includes a processor 11, a semiconductor memory 12, an auxiliary storage device 13, and a communication interface 14. These devices are coupled to each other via a bus or another signal line 15.

The processor 11 is a device that achieves various types of functions through execution of programs.

The semiconductor memory 12 may include, for example, a read only memory (ROM) in which a unified extensible firmware interface (UEFI) is stored, and a random access memory (RAM) used as a work area for the processor 11.

The processor 11 and the semiconductor memory 12 function as a so-called computer.

The auxiliary storage device 13 includes, for example, a hard disk device or a semiconductor storage. The auxiliary storage device 13 stores the programs and various types of data. The programs are used as generic terms including an operating system (OS) and application programs.

In the case of the business support server 10, one of the application programs is a program for supporting business (hereinafter also referred to as a “business support program”).

The auxiliary storage device 13 further stores data necessary for providing the business support service. In the case illustrated in FIG. 2, the auxiliary storage device 13 stores pieces of teacher data 13A of correctness, pieces of teacher data 13B for learning, and models 13C having undergone learning. One set of or a plurality of sets of the pieces of data and the model is or are stored for each of the companies that utilize the business support service.

The pieces of teacher data 13A of correctness are each provided as two pieces of table data having verified that results of matching indicate correctness, among two pieces of table data serving as targets for a matching operation.

The pieces of teacher data 13B for learning are each a piece of teacher data for machine learning, which is generated based on each of the pieces of teacher data 13A of correctness.

The models 13C having undergone learning are each a model having undergone learning, which supports matching processing for two pieces of table data.

The communication interface 14 is an interface for communicating with the user terminal 20, for example, via the network N. The communication interface 14 conforms to various types of communication standards. Example communication standards referred in here include Ethernet (registered trademark), Wireless Fidelity or Wi-Fi (registered trademark), and mobile communication systems.

### <Processing Operation in Business Support Server>

Various types of processing to be executed when the business support service is provided will now be described herein in order.

### <Matching Operation by User>

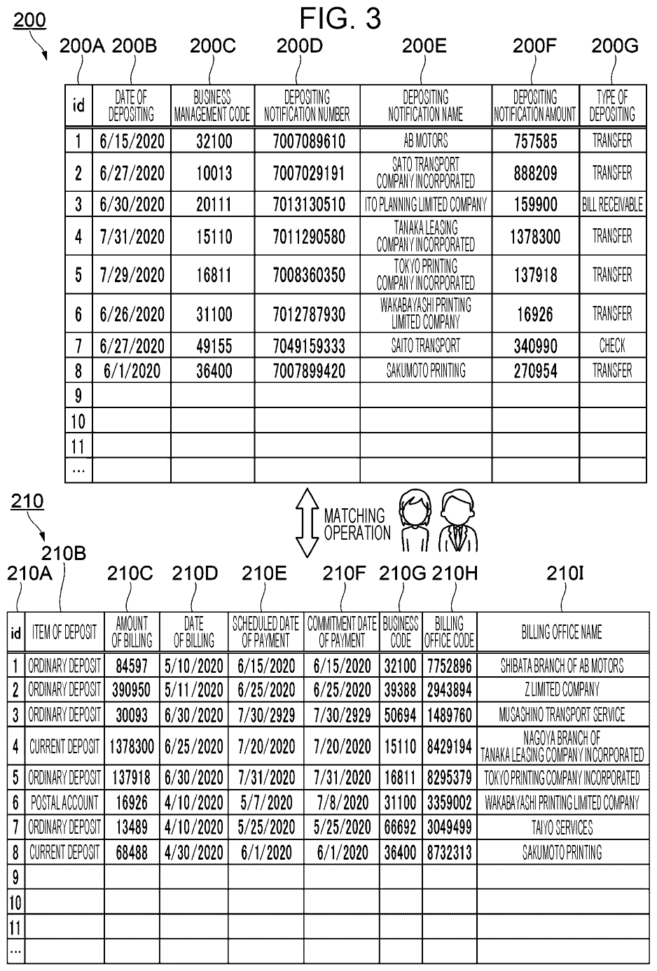

FIG. 3 is a diagram illustrating a deleting operation due to depositing of money. This deleting operation is an example of a matching operation. With reference to FIG. 3, a case where depositing data 200 and billing data 210 undergo matching with each other will now be described. Needless to say, the depositing data 200 and the billing data 210 are examples of pieces of data that undergo matching with each other.

As illustrated in FIG. 3, the depositing data 200 and the billing data 210 are pieces of data each in a table format.

For example, in the depositing data 200, there are data number 200A, date of depositing 200B, business management code 200C, depositing notification number 200D, depositing notification name 200E, depositing notification amount 200F, and type of depositing 200G. Needless to say, the illustrated items are mere examples.

In the billing data 210, there are data number 210A, item of deposit 210B, amount of billing 210C, date of billing 210D, scheduled date of payment 210E, commitment date of payment 210F, business code 210G, billing office code 210H, and billing office name 210I. Needless to say, the illustrated items are mere examples.

As described above, the depositing data 200 and the billing data 210 differ from each other in table format.

The indicated names and arrangement of pieces of column data in the depositing data 200 and the billing data 210 may differ depending on the programs employed by each of the companies or customization by each of the companies, for example. Furthermore, content of transactions appearing in the pieces of table data vary for each of the companies.

The user in charge in each of the companies visually checks the content appearing in these two pieces of table data if corresponding transactions match with each other one by one.

The depositing data 200 referred herein is an example of a piece of first table data, and the billing data 210 is an example of a piece of second table data.

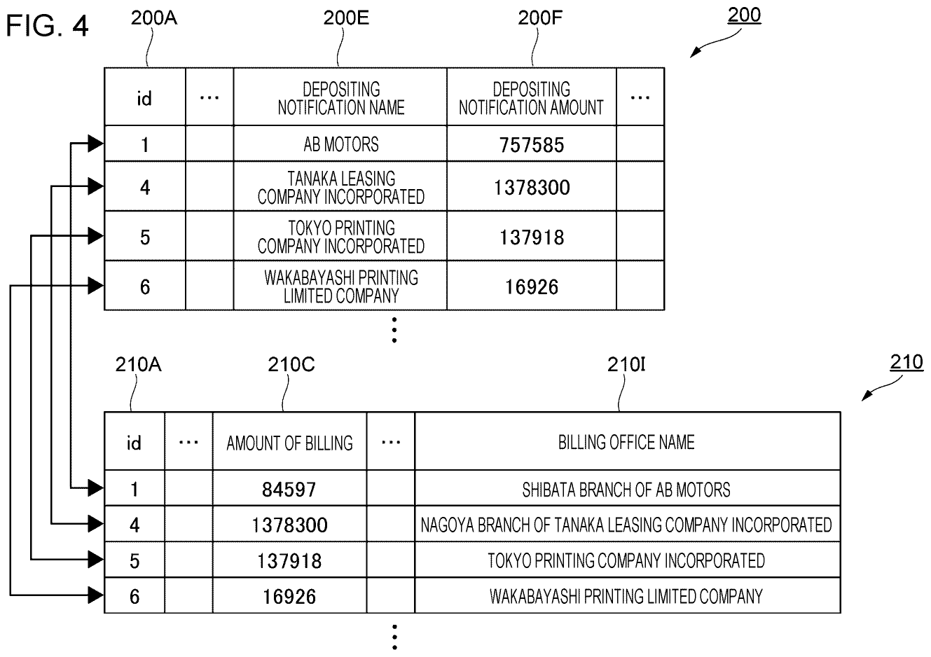

FIG. 4 is a diagram illustrating an example of a matching operation. In FIG. 4, parts corresponding to those in FIG. 3 are denoted by identical reference signs. In FIG. 4, only some pieces of transaction data are illustrated to describe relationships in which results of matching indicate correctness.

In FIG. 4, for example, a piece of transaction data of “AB Motors” in the depositing data 200 corresponds to a piece of transaction data of “Shibata Branch of AB Motors” in the billing data 210. A bidirectional arrow indicates corresponding two pieces of transaction data. One reason of why a depositing notification amount “757585” in the depositing data 200 does not match an amount of billing “84597” in the billing data 210 is that, although the amounts are in a relationship in which a result of matching indicates correctness, amounts of money pertaining to other pieces of billing data are collectively deposited. There may be cases where, from a viewpoint of a fee for depositing, amounts of money pertaining to a plurality of bills be collectively deposited.

A piece of table data acquired by extracting only pieces of transaction data having verified that results of matching indicate correctness will be hereinafter referred to as teacher data 13A of correctness (see FIG. 2).

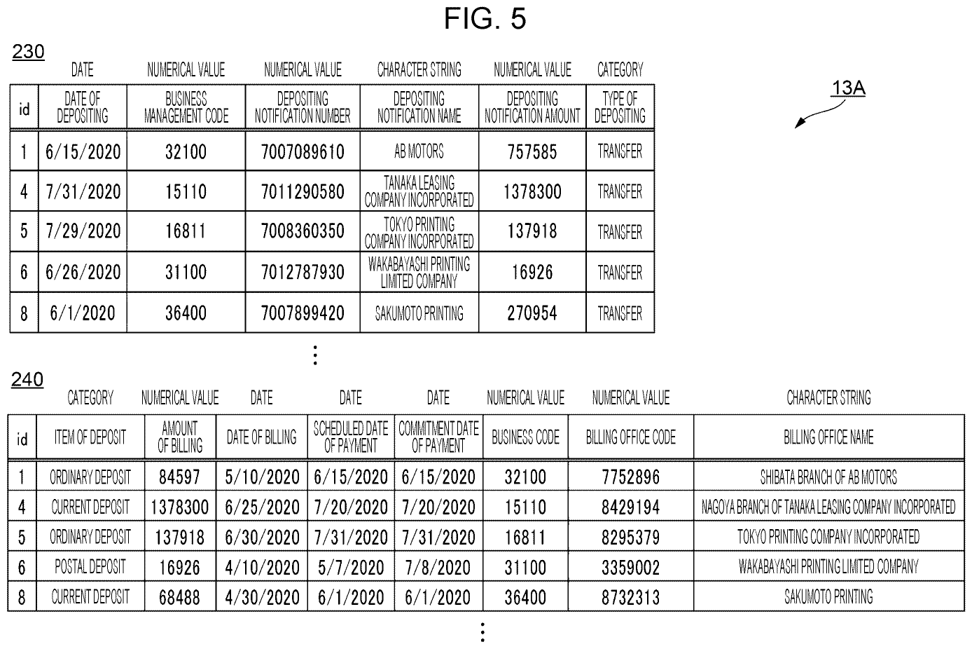

FIG. 5 is a diagram illustrating a data type for each piece of column data in the teacher data 13A of correctness. The teacher data 13A of correctness illustrated in FIG. 5 includes two pieces of table data 230 and 240. Specifically, there are two pieces of data, that is, the depositing data 230 including only pieces of transaction data having verified that results of matching with pieces of transaction data in the billing data 210 indicate correctness and the billing data 240 including only pieces of transaction data having verified that results of matching with the pieces of transaction data in the depositing data 200 indicate correctness.

In the case illustrated in FIG. 5, each row in the depositing data 230 and each row in the billing data 240 correspond to each other and are arranged in order. For example, a piece of transaction data of “AB Motors” in a first row in the depositing data 230 corresponds to a piece of transaction data of “Shibata Branch of AB Motors” in a first row in the billing data 240. The same applies to the onward rows.

In the case illustrated in FIG. 5, in the depositing data 230, the data type of “Date of Depositing” is classified into “Date”, the data type of “Business Management Code” is classified into “Numerical Value”, the data type of “Depositing Notification Number” is classified into “Numerical Value”, the data type of “Depositing Notification Name” is classified into “Character String”, the data type of “Depositing Notification Amount” is classified into “Numerical Value”, and the data type of “Type of Depositing” is classified into “Category”.

In the billing data 240, the data type of “Item of Deposit” is classified into “Category”, the data type of “Amount of Billing” is classified into “Numerical Value”, the data type of “Date of Billing” is classified into “Date”, the data type of “Scheduled Date of Payment” is classified into “Date”, the data type of “Commitment Date of Payment” is classified into “Date”, the data type of “Business Code” is classified into “Numerical Value”, the data type of “Billing Office Code” is classified into “Numerical Value”, and the data type of “Billing Office Name” is classified into “Character String”. Although “Category” is one type of “Character String”, it classifies an item having a ratio of uniqueness lower than a threshold value (for example, 0.05). The ratio of uniqueness is calculated by, for example, dividing a number of types of character strings associated with an item by a number of pieces of data. In the case illustrated in FIG. 3 described above, the number of types of character strings associated with “Type of Depositing” is three, that is, “Transfer”, “Bill Receivable”, and “Check”. Note that an item that is not classified into “Category” is classified into “Character String”.

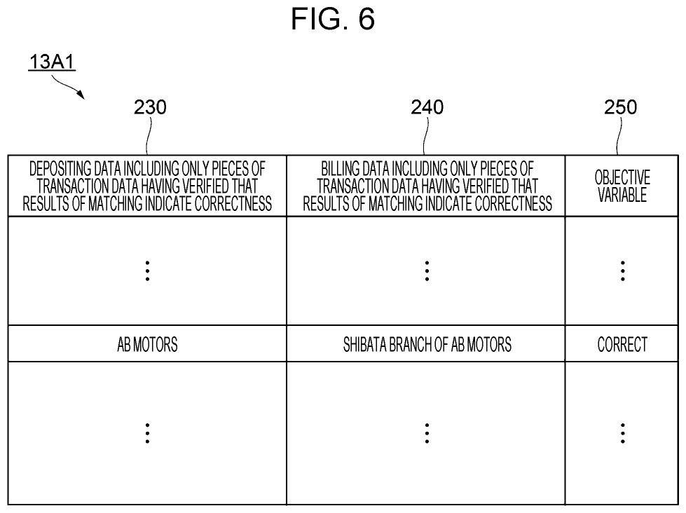

FIG. 6 is a diagram illustrating a data example of teacher data 13A1 of correctness. In FIG. 6, parts corresponding to those in FIG. 5 are denoted by identical reference signs.

The teacher data 13A1 of correctness illustrated in FIG. 6 has a data structure in which two pieces of transaction data respectively corresponding to each other in the depositing data 230 and the billing data 240 are combined with each other into one row. The corresponding two pieces of transaction data mean that, for example, one under the data number 200A (see FIG. 5) and one under the data number 210A (see FIG. 5) are identical to each other. As pieces of transaction data with data numbers identical to each other, in pieces of transaction data in the depositing data 200 and the billing data 210 (see FIG. 5), are combined with each other, teacher data 13A1 of correctness is generated. Furthermore, objective variable 250 serving as a piece of column data is added in the teacher data 13A1 of correctness, and a piece of data indicating “Correct” is recorded in each piece of transaction data.

A preliminary preparation operation in each of the companies ends as described above.

### <Uploading of Teacher Data of Correctness>

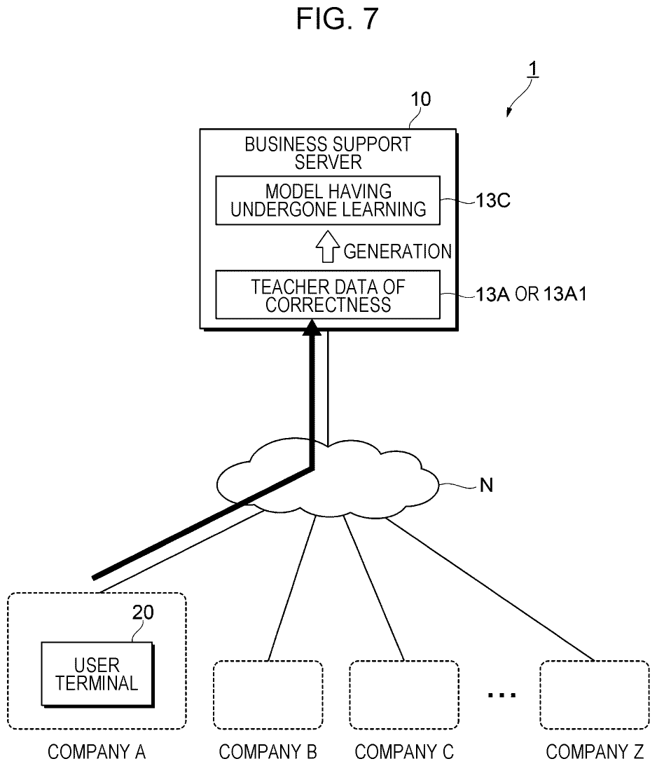

FIG. 7 is a diagram illustrating uploading of the teacher data 13A or 13A1 of correctness from the user terminal 20 to the business support server 10 (see FIG. 1). In FIG. 7, parts corresponding to those in FIG. 1 are denoted by identical reference signs.

The business support server 10 according to the present exemplary embodiment uses the uploaded teacher data 13A or 13A1 of correctness to generate a model 13C having undergone learning, which is dedicated to the company from which the data has been uploaded. The model 13c having undergone learning is used for the matching processing between the depositing data 200 (see FIG. 3) and the billing data 210 (see FIG. 3) for the company A.

### <Generation of Teacher Data for Learning>

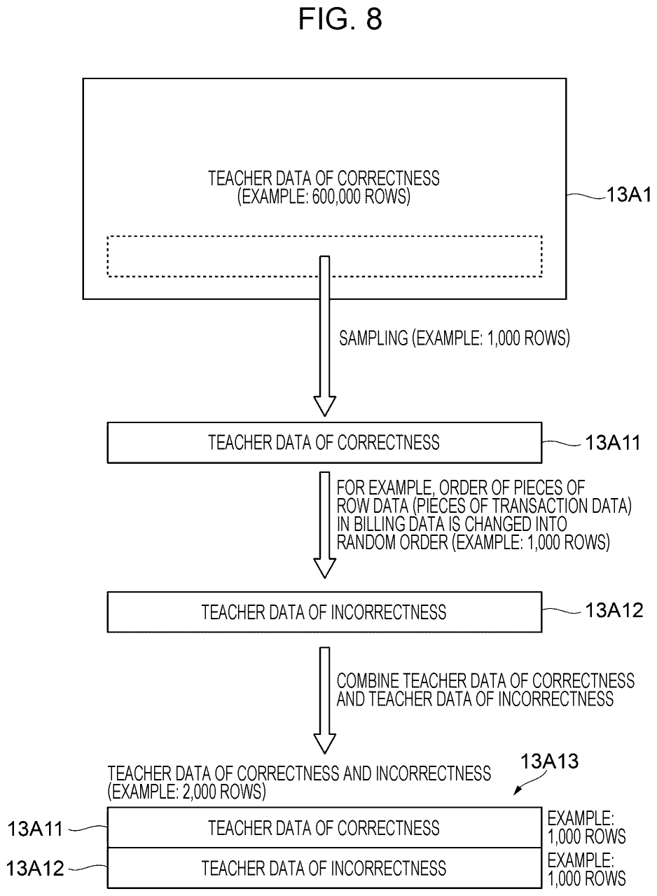

FIG. 8 is a diagram illustrating a pre-processing example for generating a model 13C having undergone learning (see FIG. 7). In FIG. 8, parts corresponding to those in FIG. 6 are denoted by identical reference signs. The pre-processing illustrated in FIG. 8 is achieved through execution of the business support program by the processor 11 (see FIG. 2).

Upon acceptance of the teacher data 13A of correctness (see FIG. 5) including the depositing data 230 (see FIG. 5) and the billing data 240 (see FIG. 5), the business support server 10 combines two pieces of table data to generate teacher data 13A1 of correctness.

In the case illustrated in FIG. 8, the teacher data 13A1 of correctness includes, for example, 600,000 rows of transaction data. Of course, the number of rows is a mere example.

The processor 11 (see FIG. 2) samples a part of the teacher data 13A1 of correctness, which is designated as a processing target, and extracts, for example, only 1,000 rows. Only some pieces of transaction data are extracted to reduce a computational load.

In FIG. 8, the extracted pieces of transaction data are referred to as teacher data 13A11 of correctness.

Next, the processor 11 uses the teacher data 13A11 of correctness to generate teacher data 13A12 of incorrectness. The teacher data 13A12 of incorrectness is generated by, for example, changing an order of pieces of row data (pieces of transaction data) in the billing data into a random order. With this change in order, a piece of transaction data in the depositing data and a piece of transaction data in the billing data, which do not have a correspondence relationship to each other, are arranged in an identical row. That is, a piece of transaction data is generated, in which the correspondence relationship between a piece of transaction data on the depositing data side and a piece of transaction data on the billing data side is collapsed.

Since there are mere changes in order in the pieces of transaction data, the generated teacher data 13A12 of incorrectness still includes 1,000 rows of transaction data.

Next, the processor 11 adds the teacher data 13A12 of incorrectness including 1,000 rows to the teacher data 13A11 of correctness including 1,000 rows to each other, and generates teacher data 13A13 of correctness and incorrectness including 2,000 rows.

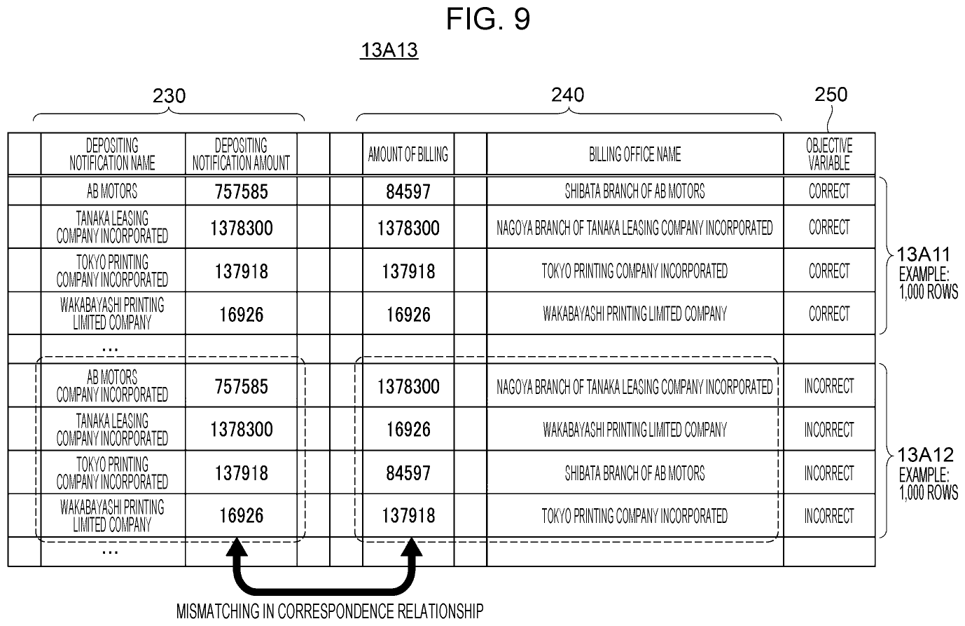

FIG. 9 is a diagram illustrating a data example of the teacher data 13A13 of correctness and incorrectness. In FIG. 9, parts corresponding to those in FIG. 6 are denoted by identical reference signs.

The teacher data 13A13 of correctness and incorrectness also has a data structure in which two pieces of transaction data respectively corresponding to each other in the depositing data 230 and the billing data 240 are combined with each other into one row.

In FIG. 9, only some pieces of column data are illustrated to easily check results of matching in correctness and incorrectness. Note that “Correct” or “Incorrect” is recorded in each objective variable 250 corresponding to each piece of transaction data. Of course, “Correct” is recorded in the teacher data 13A11 of correctness, and “Incorrect” is recorded in the teacher data 13A12 of incorrectness.

FIG. 9 illustrates a specific example of the teacher data 13A12 of incorrectness. In the case illustrated in FIG. 9, “Nagoya Branch of Tanaka Leasing Company Incorporated” in the billing data 240 is associated with “AB Motors” in the depositing data. One reason of this association is that the order of the pieces of transaction data in the billing data 240, in the teacher data 13A11 of correctness, has been changed into the random order. Note that “Incorrect” is recorded as an objective variable 250 for each of the pieces of transaction data.

### <Classification of Column Data by Data Type>

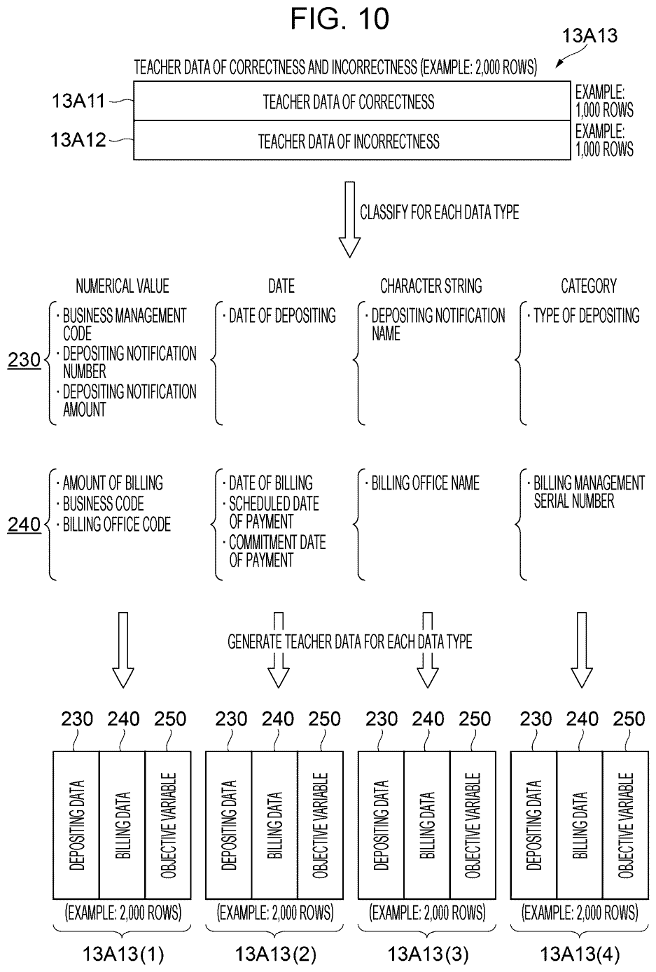

FIG. 10 is a diagram illustrating classification of column data by data type.

As the teacher data 13A13 of correctness and incorrectness is generated, the processor 11 classifies each of pieces of column data corresponding to the depositing data 230 (see FIG. 9) and each of pieces of column data corresponding to the billing data 240 (see FIG. 9) for each data type.

For example, it is possible to classify each of the pieces of column data in the depositing data 230 and the billing data 240 into one of four data types: “Numerical Value”, “Date”, “Character String”, and “Category”.

FIG. 10 illustrates a result of classification, for each data type, of an item name forming each of the pieces of data in the depositing data 230 and the billing data 240.

In the case of the depositing data 230, “Business Management Code”, “Depositing Notification Number”, and “Depositing Notification Amount” are classified into the data type of “Numerical Value”. In the case of the billing data 240, “Amount of Billing”, “Business Code”, and “Billing Office Code” are classified into the data type of “Numerical Value”.

In the case of the depositing data 230, “Date of Depositing” is classified into the data type of “Date”. In the case of the billing data 240, “Date of Billing”, “Scheduled Date of Payment,” and “Commitment Date of Payment” are classified into the data type of “Date”.

In the case of the depositing data 230, “Depositing Notification Name” is classified into the data type of “Character String”. In the case of the billing data 240, “Billing Office Name” is classified into the data type of “Character String”.

In the case of the depositing data 230, “Type of Depositing” is classified into the data type of “Category”. In the case of the billing data 240, “Item of Deposit” is classified into the data type of “Category”.

Upon completion of classification of an item name for each data type, the processor 11 generates teacher data 13A13 (1) of correctness and incorrectness, for the “Numerical Value” type, teacher data 13A13 (2) of correctness and incorrectness, for the “Date” type, teacher data 13A13 (3) of correctness and incorrectness, for the “Character String” type, and teacher data 13A13 (4) of correctness and incorrectness, for the “Category” type.

In the case of the present exemplary embodiment, a piece of teacher data of correctness and incorrectness for each data type includes teacher data of correctness including 1,000 rows and teacher data of incorrectness including 1,000 rows. Therefore, pieces of teacher data of correctness and incorrectness each include 2,000 rows of transaction data.

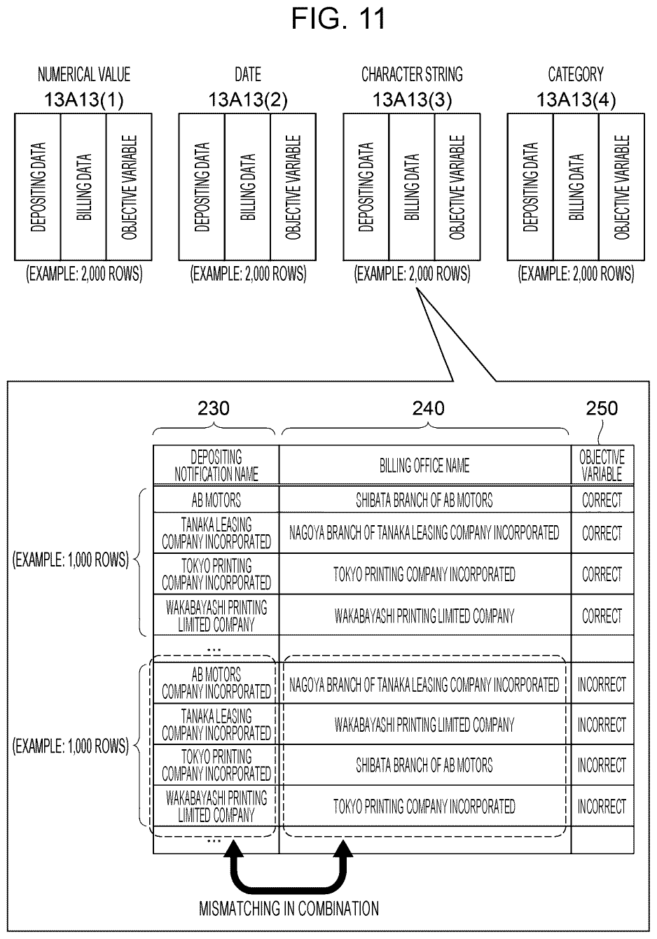

FIG. 11 is a diagram illustrating a specific example of pieces of teacher data 13A13 (1) to (4) of correctness and incorrectness, each for each data type. In FIG. 11, parts corresponding to those in FIG. 10 are denoted by identical reference signs.

For convenience of description, FIG. 11 illustrates the teacher data 13A13 (3) of correctness and incorrectness, for the “Character String” type, in which the depositing data 230 and the billing data 240 both having undergone classification each include one piece of column data.

The teacher data 13A13 (1) of correctness and incorrectness, for the “Numerical Value” type, includes three data columns in the depositing data 230 and three data columns in the billing data 240.

Furthermore, the teacher data 13A13 (2) of correctness and incorrectness, for the “Date” type, includes one data column in the depositing data 230 and three data columns in the billing data 240.

Furthermore, the teacher data 13A13 (4) of correctness and incorrectness, for the “Category” type, includes one data column in the depositing data 230 and one data column in the billing data 240.

### <Generation of Combination of Pieces of Column Data in Unit of Data Type>

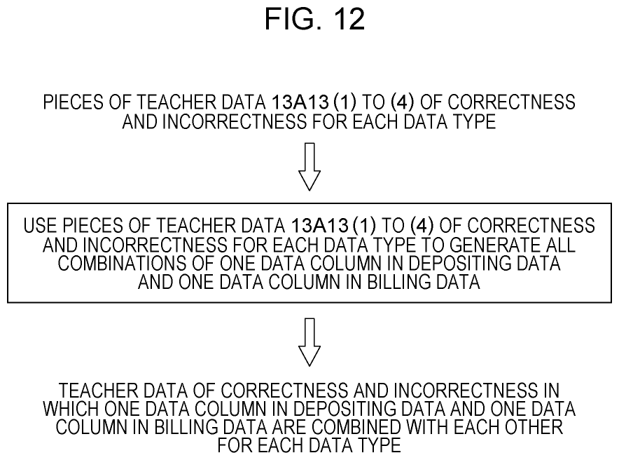

FIG. 12 is a diagram illustrating generation processing for a combination of pieces of column data in unit of data type.

As the pieces of teacher data 13A13 (1) to (4) of correctness and incorrectness each for each data type are generated, the processor 11 uses the pieces of teacher data 13A13 (1) to (4) of correctness and incorrectness each for each data type to generate all combinations of one of the data columns in the depositing data 230 (see FIG. 11) and one of the data columns in the billing data 240 (see FIG. 11).

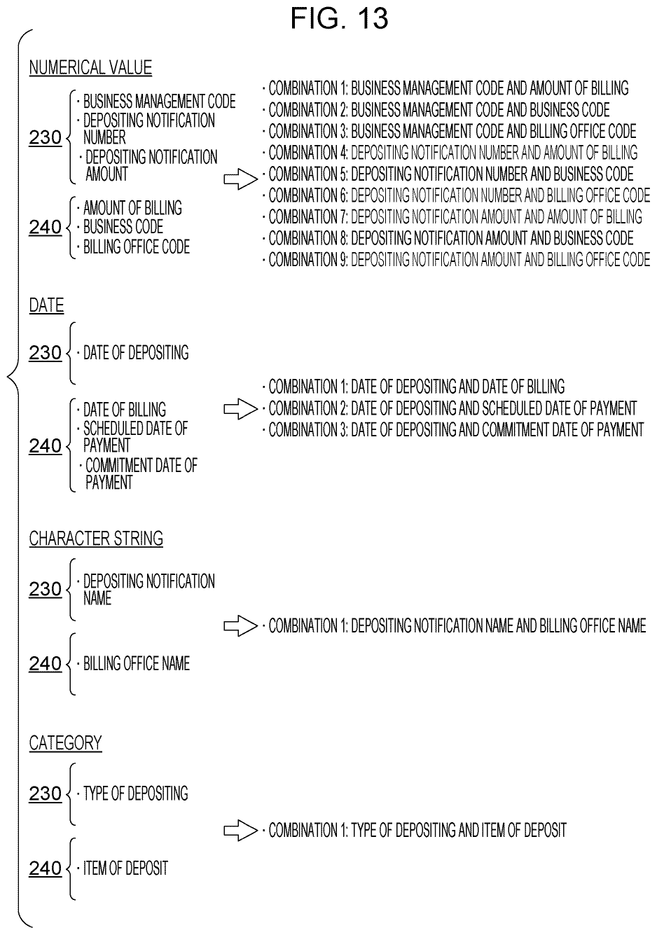

FIG. 13 is a diagram illustrating combination examples of data columns each for each data type. In FIG. 13, parts corresponding to those in FIG. 10 are denoted by identical reference signs.
For the “Numerical Value” type, for example, nine combinations are generated.
For the “Date” type, for example, three combinations are generated.
For the “Character String” type, for example, one combination is generated.
For the “Category” type, for example, one combination is generated.
The pieces of teacher data of correctness and incorrectness each corresponding to each of the combinations each include 2,000 rows of transaction data.

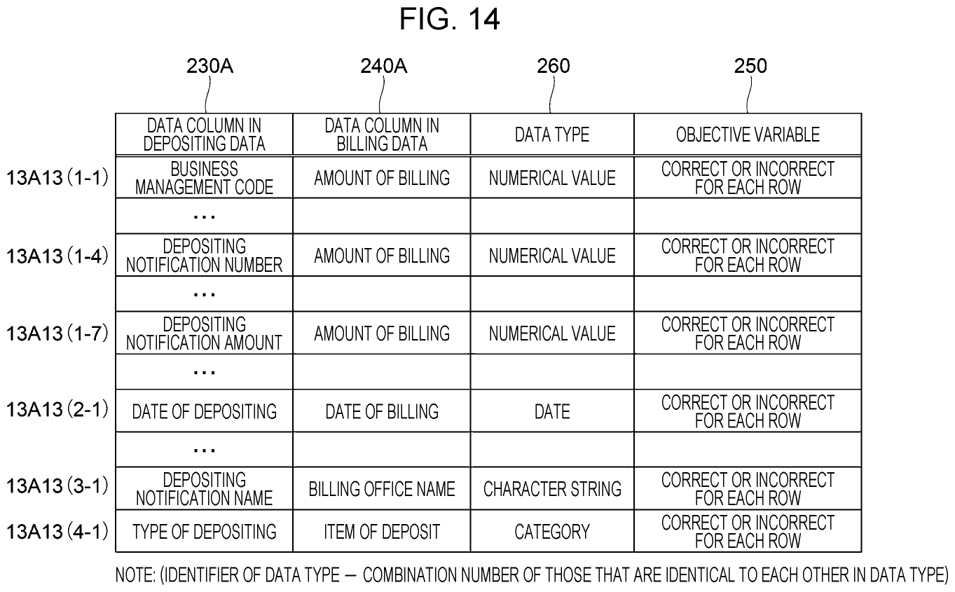

FIG. 14 is a diagram illustrating pieces of teacher data 13A13 (1-1) to (1-9), 13A13 (2-1) to (2-3), 13A13 (3-1), and 13A13 (4-1) of correctness and incorrectness respectively corresponding to combinations of data columns prepared each for each data type. In FIG. 14, parts corresponding to those in FIGS. 2 and 10 are denoted by identical reference signs.

The number at the top in the parentheses indicates an identifier of the data type, and the number at the end in the parentheses indicates a combination number for the data type. Incidentally, among the identifiers, “1” represents Numerical Value, “2” represents Date, “3” represents Character String, and “4” represents Category.

The pieces of teacher data 13A13 (1-1) to 13A13 (4-1) of correctness and incorrectness illustrated in FIG. 14 each include a data column 230A in the depositing data, a data column 240A in the billing data, a data type 260, and the objective variable 250.

The pieces of teacher data 13A13 (1-1) to 13A13 (4-1) of correctness and incorrectness each include 2,000 rows of transaction data. Of course, half of the rows of transaction data serves as data of correctness, and another half of the rows of transaction data serves as data of incorrectness.

### <Generation of Teacher Data for Learning Designated in Which Feature Amount is Designated>

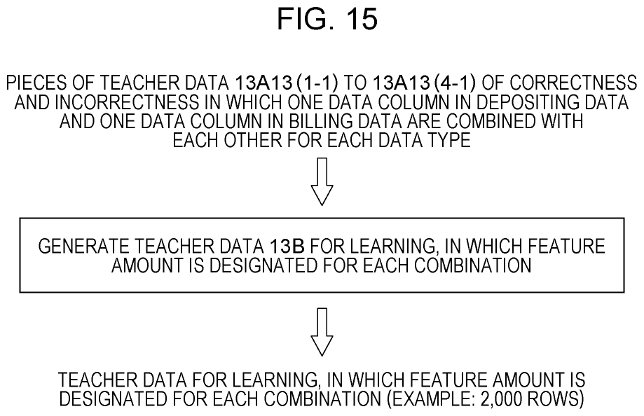

FIG. 15 is a diagram illustrating generation processing for teacher data for learning.

As the pieces of teacher data 13A13 (1-1) to 13A13 (4-1) of correctness and incorrectness are generated, in each of which one of the data columns in the depositing data and one of the data columns in the billing data for each data type are combined with each other, the processor 11 generates teacher data 13B for learning in which a feature amount is designated for each combination (see FIG. 2). The teacher data 13B for learning is also an example of teacher data of correctness and incorrectness.

Note that the teacher data 13B for learning is an example of a piece of second teacher data.

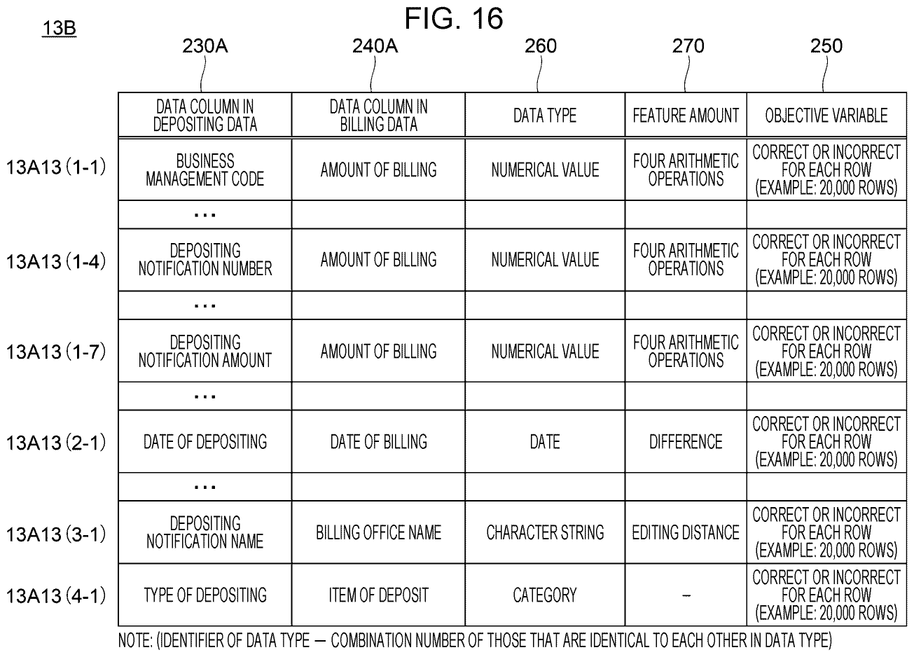

FIG. 16 is a diagram illustrating an example of teacher data 13B for learning, in which a feature amount is designated for each combination. In FIG. 16, parts corresponding to those in FIG. 14 are denoted by identical reference signs.

Each row in the teacher data 13B for learning illustrated in FIG. 16 corresponds to each row in the pieces of teacher data 13A13 (1-1) to 13A13 (4-1) of correctness and incorrectness illustrated in FIG. 14.

As illustrated in FIG. 16, for a feature amount 270, in the pieces of teacher data 13A13 (1-1) to (1-9) of correctness and incorrectness, for the “Numerical Value” type, “Four Arithmetic Operations” is designated. The four arithmetic operations include addition, subtraction, multiplication, and division.

For a feature amount 270, in the pieces of teacher data 13A13 (2-1) to (2-3) of correctness and incorrectness, for the “Date” type, “Difference” is designated.

For a feature amount 270, in the teacher data 13A13 (3-1) of correctness and incorrectness, for the “Character String” type, “Editing Distance” is designated.

Incidentally, no feature amount 270 is designated, in the teacher data 13A13 (4-1) of correctness and incorrectness, for the “Category” type. Therefore, “-” is illustrated in the drawing.

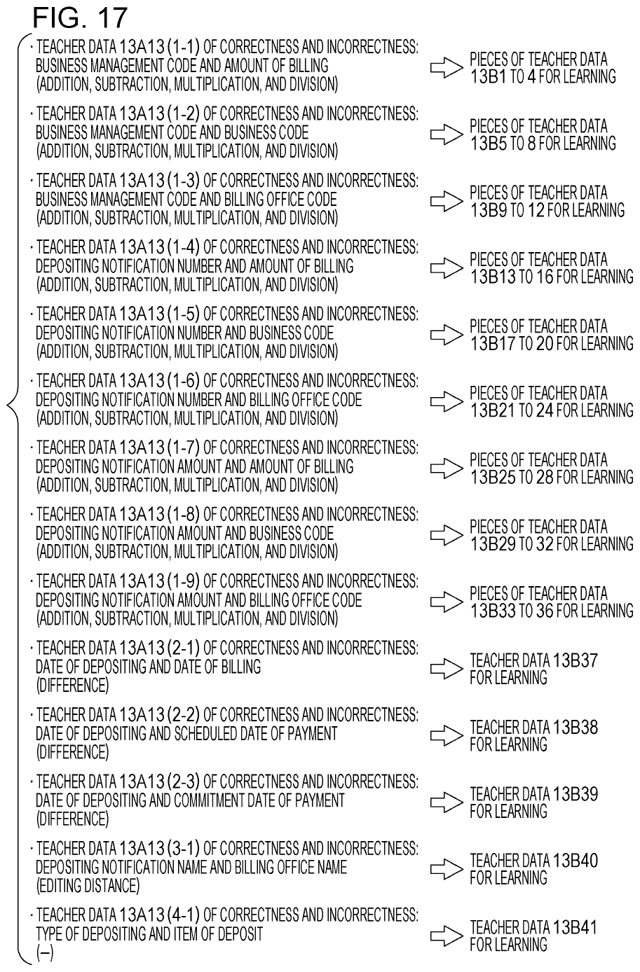

FIG. 17 is a diagram illustrating a generation example of pieces of teacher data for learning, each of which corresponds to a combination. In FIG. 17, parts corresponding to those in FIG. 16 are denoted by identical reference signs.

As described above, “Addition”, “Subtraction”, “Multiplication”, and “Division” are used to calculate a feature amount 270 (see FIG. 16) corresponding to each of those in the pieces of teacher data 13A13 (1-1) to (1-9) of correctness and incorrectness, for the “Numerical Value” type.

Therefore, four pieces of teacher data 13B1, 13B2, 13B3, and 13B4 for learning, in which arithmetic operations used to calculate feature amounts 270 differ from each other in content, are generated from, for example, the teacher data 13A13 (1-1) of correctness and incorrectness, in which “Business Management Code” in the depositing data and “Amount of Billing” in the billing data are combined with each other.

In each piece of transaction data in the teacher data 13B1 for learning, for example, a value of addition between “Business Management Code” and “Amount of Billing” is recorded as a feature amount 270.

In each piece of transaction data in the teacher data 13B2 for learning, for example, a value of subtraction between “Business Management Code” and “Amount of Billing” is recorded as a feature amount 270.

In each piece of transaction data in the teacher data 13B3 for learning, for example, a value of multiplication between “Business Management Code” and “Amount of Billing” is recorded as a feature amount 270.

In each piece of transaction data in the teacher data 13B4 for learning, for example, a value of division between “Business Management Code” and “Amount of Billing” is recorded as a feature amount 270. In a division arithmetic operation, for example, “Business Management Code” is used as a numerator and “Amount of Billing” is used as a denominator.

Similarly, four pieces of teacher data for learning are generated from the pieces of teacher data 13A13 (1-2) to (1-9) of correctness and incorrectness.

Specifically, four pieces of teacher data 13B5 to 8 for learning are generated from the teacher data 13A13 (1-2) of correctness and incorrectness, four pieces of teacher data 13B9 to 12 for learning are generated from the teacher data 13A13 (1-3) of correctness and incorrectness, and four pieces of teacher data 13B13 to 16 for learning are generated from the teacher data 13A13 (1-4) of correctness and incorrectness. The same applies to onward items, and their descriptions will be omitted.

One piece of teacher data 13B37 for learning is generated from the teacher data 13A13 (2-1) of correctness and incorrectness, in which “Date of Depositing” in the depositing data and “Date of Billing” in the billing data are combined with each other. For its feature amount 270, a result (that is, a value of difference) of subtraction of “Date of Billing” from “Date of Depositing”, for example, is recorded.

One piece of teacher data 13B38 for learning is generated from the teacher data 13A13 (2-2) of correctness and incorrectness, in which “Date of Depositing” in the depositing data and “Scheduled Date of Payment” in the billing data are combined with each other. For its feature amount 270, a result (that is, a value of difference) of subtraction of “Scheduled date of Payment” from “Date of Depositing”, for example, is recorded.

One piece of teacher data 13B39 for learning is generated from the teacher data 13A13 (2-3) of correctness and incorrectness, in which “Date of Depositing” in the depositing data and “Commitment Date of Payment” in the billing data are combined with each other. For its feature amount 270, a result (that is, a value of difference) of subtraction of “Commitment Date of Payment” from “Date of Depositing”, for example, is recorded.

One piece of teacher data 13B 40 for learning is generated from the teacher data 13A13 (3-1) of correctness and incorrectness, in which “Depositing Notification Name” in the depositing data and “Billing Office Name” in the billing data are combined with each other. For its feature amount 270, an editing distance from “Depositing Notification Name” to “Billing Office Name”, for example, is recorded.

One piece of teacher data 13B41 for learning is generated from the teacher data 13A13 (4-1) of correctness and incorrectness, in which “Type of Depositing” in the depositing data and “Item of Deposit” in the billing data are combined with each other. For its feature amount 270, an editing distance from “Type of Depositing” to “Item of Deposit”, for example, is recorded.

### <Generation of Model Having Undergone Learning>

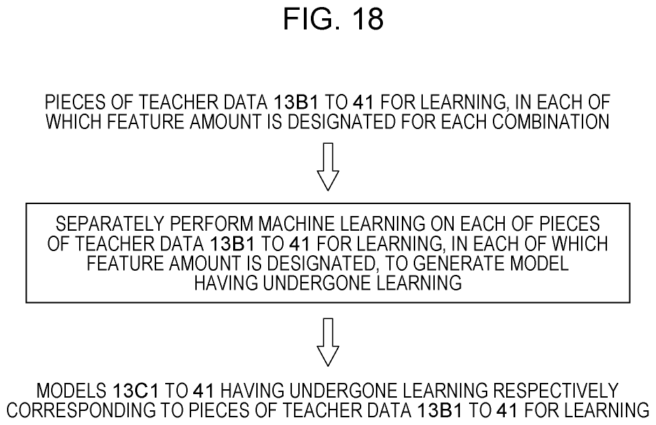

FIG. 18 is a diagram illustrating generation process for a model having undergone learning.

As the pieces of teacher data 13B1 to 41 for learning, in each of which the feature amount for each combination is designated, are generated, the processor 11 separately uses the pieces of teacher data 13B1 to 41 for learning, in each of which the feature amount is designated, to perform machine learning to generate models 13C1 to 41 having undergone learning.

For example, the teacher data 13B1 for learning, in which the feature amount is designated, is used to perform machine learning to generate the model 13C1 having undergone learning for each combination of pieces of column data that are identical to each other in data type. The model 13C1 having undergone learning is a model that has undergone learning, for an addition arithmetic operation, on a relationship between “Business Management Code” and “Amount of Billing” in input data. The same applies to the other models 13C2 to 41 having undergone learning.

### <Evaluation of Model Having Undergone Learning>

Next, the models 13C1 to 41 having undergone learning, each for each combination of pieces of column data that are identical to each other in data type, are evaluated. In other words, ability of outputting a combination of pieces of transaction data for each of which a result of matching indicates correctness is evaluated. For example, a degree of probability that an output of each of the models 13C1 to 41 having undergone learning indicates correctness is outputted as a result of valuation.

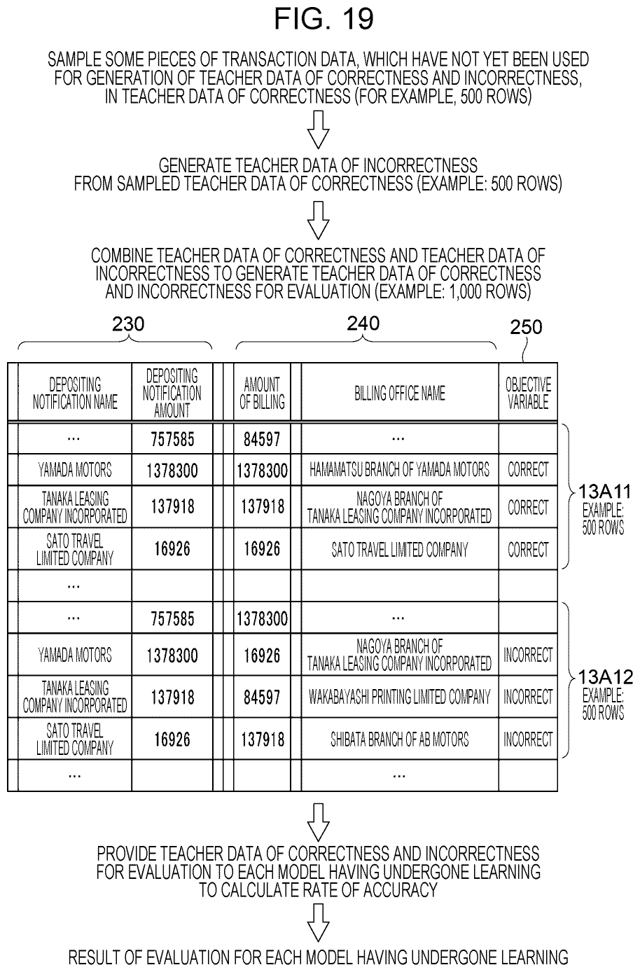

FIG. 19 is a diagram illustrating evaluation processing for the models 13C1 to 41 having undergone learning, which are each generated for each combination of pieces of column data. In FIG. 19, parts corresponding to those in FIG. 9 are denoted by identical reference signs.

The processor 11 first generates data for evaluation (hereinafter referred to as “evaluation data”).

Therefore, the processor 11 samples some pieces of transaction data (some of rest of 600,000 rows excluding 1,000 rows) that have not yet been used for generation of the teacher data 13A13 of correctness and incorrectness (see FIG. 9), in the teacher data 13A1 of correctness (see FIG. 6). For example, 500 rows of pieces of transaction data are sampled. Note that sampling of 500 rows is a mere example, and the number of rows may be more or less than 500 rows.

Next, the processor 11 generates teacher data of incorrectness from the teacher data of correctness, which has been sampled. In the case of this example, teacher data of incorrectness, which includes 500 rows, for example, is generated.

After that, the processor 11 combines the teacher data of correctness and the teacher data of incorrectness with each other to generate teacher data of correctness and incorrectness for evaluation. The content of the processing described so far is identical to the content of the processing illustrated in FIG. 8. Note that the teacher data of correctness includes 500 rows, and the teacher data of incorrectness includes 500 rows. Therefore, the teacher data of correctness and incorrectness for evaluation includes 1,000 rows of transaction data.

FIG. 19 illustrates a data example of the teacher data of correctness and incorrectness for evaluation, which has been generated. Its data structure is identical to the data structure of the teacher data 13A13 of correctness and incorrectness illustrated in FIG. 9. However, the pieces of transaction data differ from each other in content.

As the pieces of transaction data for evaluation are generated, the processor 11 provides the teacher data of correctness and incorrectness for evaluation to each of the models 13C1 to 41 having undergone learning, and calculates a rate of accuracy.

Specifically, the processor 11 provides each of the pieces of transaction data provided as a pair of those in the depositing data 230 and the billing data 240 to the model 13C1 having undergone learning as input data, and acquires output data for “Correct” or “Incorrect” for each input data.

Next, the processor 11 determines whether the output data for “Correct” or “Incorrect” with respect to the input data matches the objective variable 250 in the input data. When the output data and the objective variable 250 match each other in correctness and incorrectness, “Correct” is determined, and, when the output data and the objective variable 250 do not match each other in correctness and incorrectness, “Incorrect” is determined.

Then, for each of the models having undergone learning, a total number of the pieces of data, that is, a total number of the pieces of teacher data of correctness and incorrectness for evaluation is used as a denominator and a number of pieces of transaction data for which correctness and incorrectness have been determined as correct as a numerator, and a rate of accuracy is calculated. A value of the calculated rate of accuracy will be hereinafter referred to as a score.

As a result, a result of the evaluation for each of the models 13C1 to 41 having undergone learning is acquired.

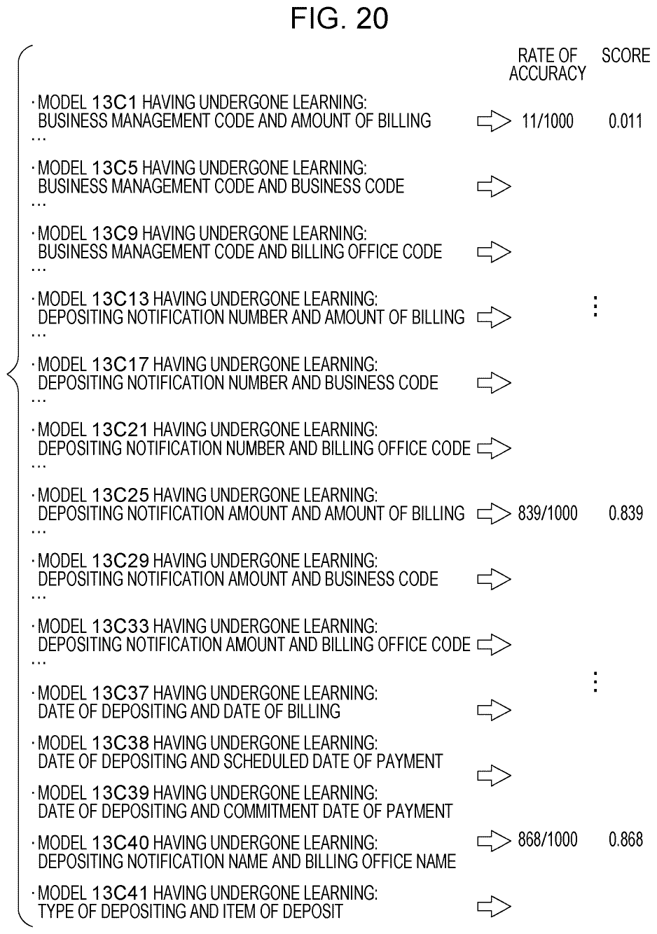

FIG. 20 is a diagram illustrating an example of scores corresponding to the models 13C1 to 41 having undergone learning. In FIG. 20, from a viewpoint of clarity, description of some of the models 13C having undergone learning (see FIG. 2) is omitted.

For the model 13C1 having undergone learning, for example, its score is 0.011. This indicates that, in determination of correctness and incorrectness for the model 13C1 having undergone learning with respect to 1,000 rows of transaction data, only 11 rows have been determined as correct.

For the model 13C25 having undergone learning, its score is 0.839. This indicates that, in determination of correctness and incorrectness for the model 13C25 having undergone learning with respect to 1,000 rows of transaction data, 839 rows have been determined as correct.

For the model 13C40 having undergone learning, its score is 0.868. This indicates that, in determination of correctness and incorrectness for the model 13C40 having undergone learning with respect to 1,000 rows of transaction data, 868 rows have been determined as correct.

### Example of Providing Business Support Service

An example of providing the business support service that uses a result of evaluation on such a model having undergone learning as described above will now be described herein.

### <Example 1 of Provision>

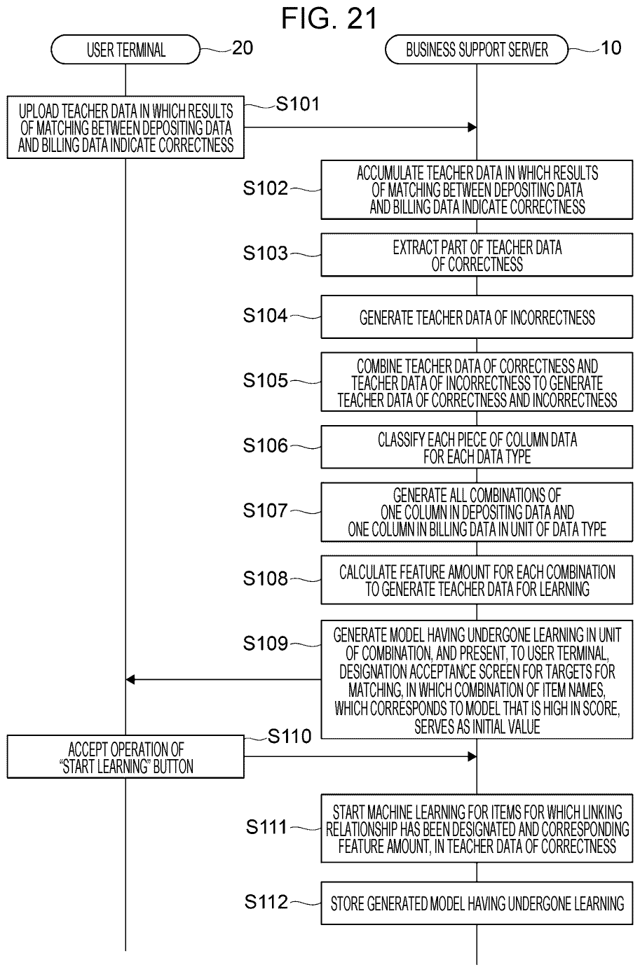

FIG. 21 is a sequence diagram illustrating an example of providing the business support service. A symbol S illustrated in the drawing means a step.

The user terminal 20 first uploads, to the business support server 10, teacher data 13A1 (see FIG. 6) in which results of matching between depositing data and billing data indicate correctness (step 101).

Upon acceptance of the uploaded data, the business support server 10 accumulates the teacher data 13A1 in which results of matching between the depositing data and the billing data indicate correctness (step 102). The teacher data 13A1 of correctness is accumulated in an area dedicated to the user who has upload the data.

Next, the business support server 10 extracts a part of the teacher data of correctness (step 103).

Next, the business support server 10 generates teacher data 13A12 of incorrectness (step 104).

In addition, the business support server 10 combines the teacher data of correctness and the teacher data of incorrectness to generate teacher data 13A13 of correctness and incorrectness (see FIG. 9) (step 105).

Steps 103 to 105 in the processing correspond to the steps in the processing described with reference to FIGS. 8 and 9.

Next, the business support server 10 classifies each of pieces of column data for each data type (step 106). The step in the processing corresponds to the step in the processing described with reference to FIGS. 10 and 11.

After that, the business support server 10 generates all combinations of one column in the depositing data and one column in the billing data in unit of data type (step 107). The step in the processing corresponds to the step in the processing described with reference to FIGS. 12 to 14.

Next, the business support server 10 calculates a feature amount for each combination and generates teacher data for learning (step 108). The step in the processing corresponds to the step in the processing described with reference to FIGS. 15 to 17.

After that, the business support server 10 generates models 13C1 to 41 having undergone learning (see FIG. 18) each in unit of combination, and presents, to the user terminal 20, a designation acceptance screen for targets for matching, in which a combination of item names, which corresponds to a model that is high in score, serves as an initial value (step 109). Part of this processing corresponds to the processing described with reference to FIGS. 18 to 20.

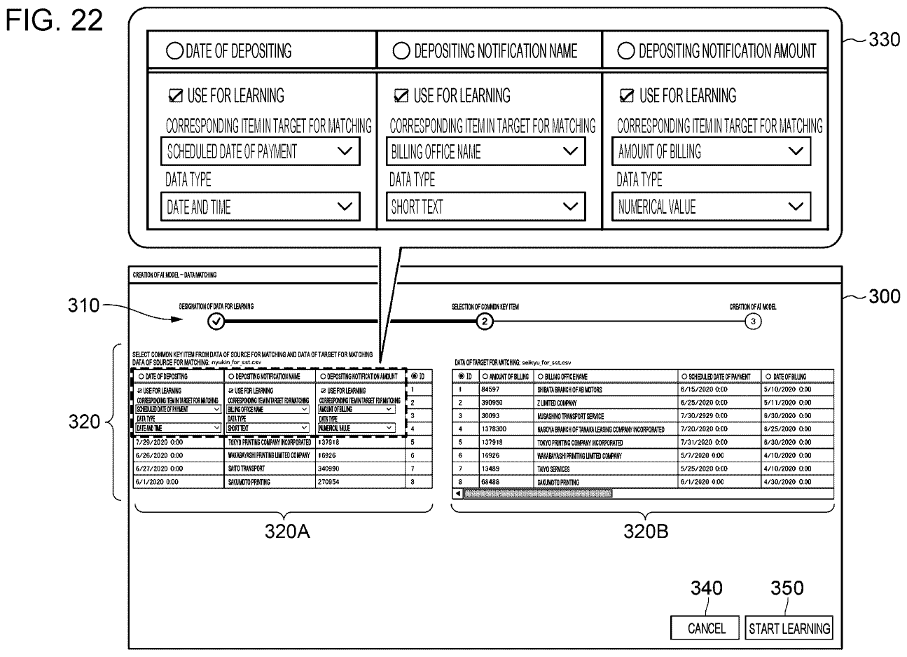

FIG. 22 is a diagram illustrating a display example of a designation acceptance screen 300 for targets for matching, which is to be displayed on the user terminal 20.

The designation acceptance screen 300 for targets for matching, which is illustrated in FIG. 22, includes a progress bar 310 and a setting field 320 for a target of association. The term “association” used herein refers to an action of selectively associating with each other and linking to each other one item in one piece of table data with one item in another one piece of table data. More specifically, it is an action of, when a feature amount is to be calculated, associating with each other items that are considered to have a high correlation with an objective variable desired to be acquired. The “objective variable desired to be acquired” used in this example refers to a combination for which a result of matching between billing data and input data indicates correctness.

In the case of the progress bar 310 illustrated in FIG. 22, a progress status is presented in three stages.

The first stage is “Designation of Data for Learning”. This stage is a stage for accepting teacher data 13A1 of correctness (see FIG. 6).

The second stage is “Designation of Item to be Associated”. In the case of the progress bar 310, a label “Selection of Common Key Item” is provided. In the case illustrated in FIG. 22, the progress currently lies at the second stage.

The third stage is “Generation of Model having undergone Learning”. In the case of the progress bar 310, a label “Creation of Artificial intelligence (AI) model” is provided. The “model having undergone learning” used in the third stage means a model having undergone learning, which is used for executing matching processing on behalf of a human. In other words, the “model having undergone learning” used in the third stage refers to a model having undergone learning, which is used in matching processing of two pieces of table data on which no matching operation has been performed by a human.

Therefore, the “model having undergone learning” used in the third stage differs from a model having undergone learning, which is to be generated for each combination of data columns described above.

Upon start of generation of a model having undergone learning, the progress lies at the third position in the progress bar 310.

The setting field 320 for a target of association has two regions 320A and 320B.

In the region 320A, table data serving as a source for matching is displayed. In the present exemplary embodiment, “Depositing Data” is displayed. In the region 320B, table data serving as a target for matching is displayed. In the present exemplary embodiment, “Billing Data” is displayed.

In FIG. 22, a part of the region 320A is enlarged and illustrated in a balloon 330.

In the case illustrated in FIG. 22, the balloon 330 indicates three input items of “Date of Depositing”, “Depositing Notification Name”, and “Depositing Notification Amount”.

As illustrated in step 109 (see FIG. 21), the designation acceptance screen 300 for targets for matching illustrated in FIG. 22 presents, as initial values, combinations of pieces of column data, which each corresponds to a model having undergone learning, which is high in score.

In “Date of Depositing”, for example, “Scheduled Date of Payment” on which a high score is to be acquired when combined with “Date of Depositing” is displayed as an initial value.

In the case illustrated in FIG. 22, check-boxes each labeled as “Use for Learning” are each initially applied with a check mark.

Associating “Date of Depositing” and “Scheduled Date of Payment” with each other and allowing machine learning to proceed make it possible, even when depositing data and billing data before having undergone matching by a human are inputted, to increase a possibility that a rate of accuracy of a result of matching based on a finally generated model having undergone learning increases.

Note that the user is also allowed to separately remove the check marks in the check-boxes.

When the user accepts the recommendation displayed as the initial value, for example, the user applies a check mark in a selection field displayed to left of “Date of Depositing”. As a result, a check mark is also applied in a selection field displayed to left of “Scheduled Date of Payment” in the region 320B.

However, when a check mark has been applied in the check-box labeled as “Use for Learning”, no additional operation may be necessary for the user.

As the business support server 10 (see FIG. 1) accepts the designation, the business support server 10 updates the region 320A and the region 320B being displayed to pair “Date of Depositing” and “Scheduled Date of Payment” with each other, for example.

Incidentally, for “Depositing Notification Name”, “Billing Office Name” is displayed as the initial value. Furthermore, for “Depositing Notification Amount”, “Amount of Billing” is displayed as the initial value.

Note that, for the models 13C1 to 41 having undergone learning (see FIG. 20) each for each combination of pieces of column data that are identical to each other in data type, there may be cases where different content of arithmetic operation may be used to calculate a feature amount even when an identical combination of pieces of column data is used. When a data type is “Numerical Value”, for example, four models 13C having undergone learning, in which types of the four arithmetic operations to be used to calculate a feature amount differ from each other, are generated for one combination of pieces of column data. Therefore, an initial value may include a type of the four arithmetic operations to be used for machine learning.

In the case illustrated in FIG. 22, a “Cancel” button 340 and a “Start Learning” button 350 are disposed at lower right positions in the designation acceptance screen 300 for targets for matching.

Upon acceptance of an operation of the “Cancel” button 340, the business support server 10 cancels all the designations for the targets of association, which have been accepted so far. Note that, upon acceptance of an operation of the “Cancel” button 340, the generation operation for a model having undergone learning for this time may be temporarily stopped.

On the other hand, upon acceptance of an operation of the “Start Learning” button 350 (step 110 in FIG. 21), the business support server 10 starts machine learning for the items for which an association relationship in the teacher data of correctness has been designated and the corresponding feature amount (step 111 in FIG. 21). At this point in time, the position of the current stage on the progress bar 310 moves to the third stage.

After that, the business support server 10 stores the generated model having undergone learning (step 112 in FIG. 21).

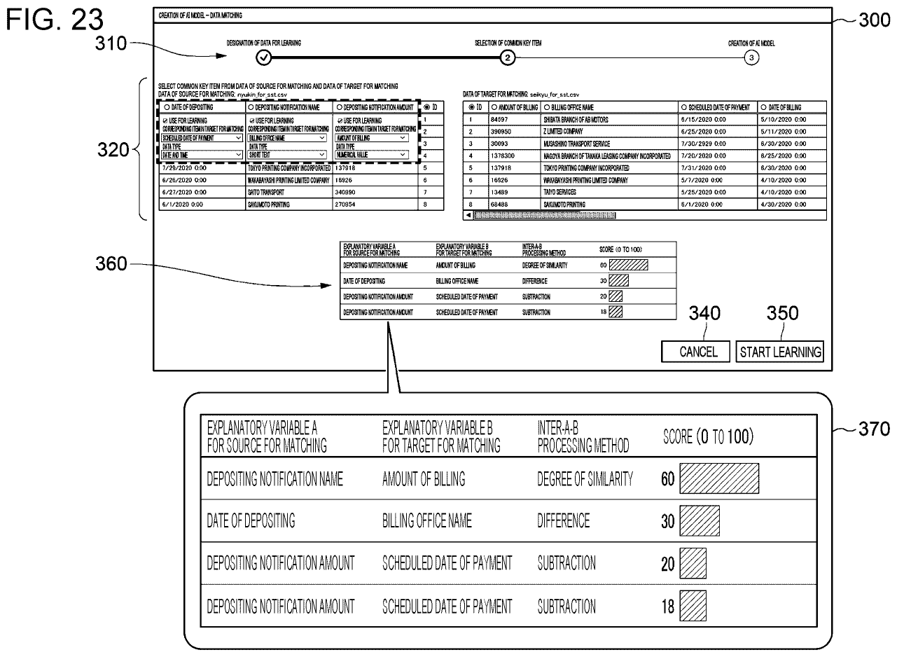

FIG. 23 is a diagram illustrating another display example of the designation acceptance screen 300 for targets for matching. In FIG. 23, parts corresponding to those in FIG. 22 are denoted by identical reference signs.

The designation acceptance screen 300 for targets for matching illustrated in FIG. 23 includes a combination information field 360, based on which the initial values have been set. FIG. 23 illustrates in an enlarged manner the combination information field 360 in a balloon 370.

The combination information field 360 illustrated in FIG. 23 includes, as display items, “Explanatory Variable A for Source for Matching”, “Explanatory Variable B for Target for Matching”, “Inter-A-B Processing Method”, and “Score (0 to 100)”.

In the present exemplary embodiment, a source for matching is “Depositing Data”, and a target for matching is “Billing Data”.

In the combination information field 360, combinations that are high in score value are displayed. For example, top ten combinations that are high in score value are displayed, regardless of the data type. However, in FIG. 23, only four combinations are illustrated due to a limited space on the paper sheet. Note that, for combinations corresponding to the 11th to 20th of those that are high in score value, for example, only combinations that are higher in score value than a predetermined threshold value may be displayed in the combination information field 360.

In the case illustrated in FIG. 23, a combination acquired by calculating a feature amount between “Depositing Notification Name” and “Billing Office Name” based on “Degree of Similarity” is highest in score. Incidentally, the score is “60”. Although the feature amounts are evaluated based on “Degree of Similarity” in FIG. 23, “Editing Distance” may be used as described above. Incidentally, “Editing Distance” is a form of the degree of similarity. It is possible to calculate a degree of similarity as “Matching Rate”. The score referred in here is an example of a degree of accuracy of prediction. Furthermore, in the case illustrated in FIG. 23, degrees of accuracy of prediction are displayed in a list format each for each combination candidate.

Incidentally, it is understood that, even in the case of the designation acceptance screen 300 for targets for matching, which is illustrated in FIG. 22 and described above, a candidate of a target for matching, which is displayed as an initial value, becomes higher in score in terms of a relationship with a source for matching than a combination with another item. However, it is impossible to know an order relationship between the scores and magnitudes of the scores.

On the other hand, the information field 360 is displayed as described above on the designation acceptance screen 300 for targets for matching, which is illustrated in FIG. 23. Therefore, it is possible to check an order relationship of scores between combinations of explanatory variables and values of the scores each corresponding to each of the combinations. As a result, sources for determining whether or not to designate a candidate recommended as an initial value as a combination target are clarified.

In the case where the information field 360 illustrated in FIG. 23 is displayed, it is understood that there is no combination from which it is possible to acquire a high score, except the combination of “Depositing Notification Name” and “Billing Office Name” between which a degree of similarity serves as a feature amount.

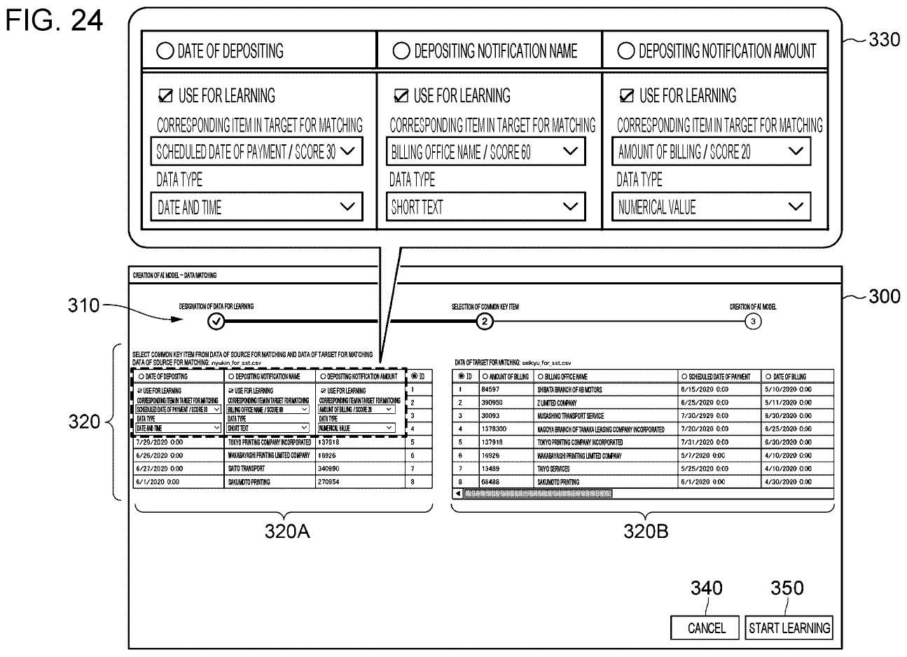

FIG. 24 is a diagram illustrating still another display example of the designation acceptance screen 300 for targets for matching. In FIG. 24, parts corresponding to those in FIG. 22 are denoted by identical reference signs.

The designation acceptance screen 300 for targets for matching, which is illustrated in FIG. 24, includes a score in a display field for an initial value of a candidate of matching. In this case, the user is able to determine, even in the setting field 320 for a target of association, whether or not the candidate displayed as the initial value is suitable as an explanatory variable for a target for matching.

Note that, even when other items are to be displayed in a pull-down manner, scores each calculated for each item are also displayed.

### <Use Example 2>

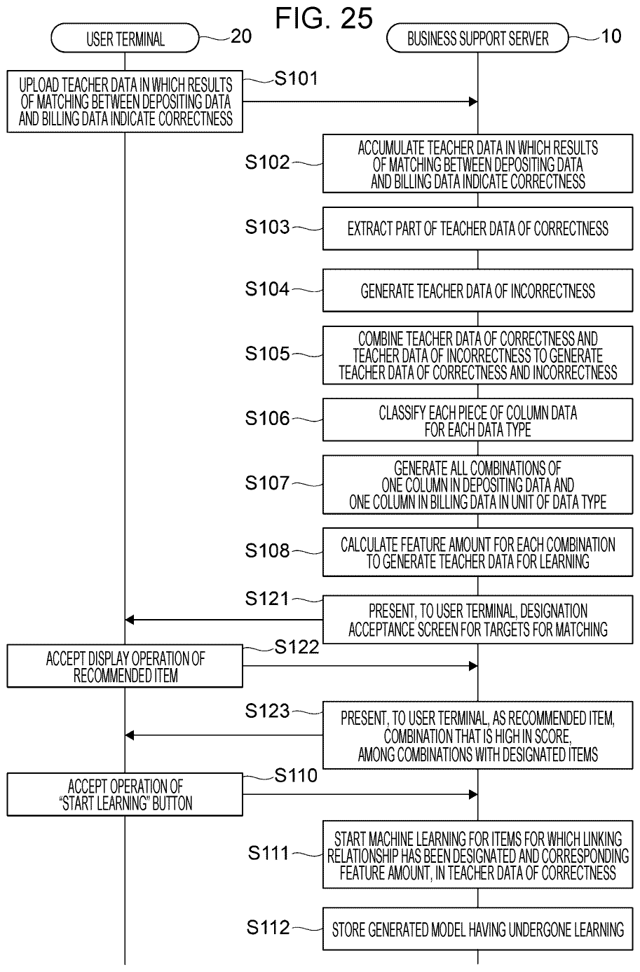

FIG. 25 is a sequence diagram illustrating another example of providing the business support service. In FIG. 25, parts corresponding to those in FIG. 21 are denoted by identical reference signs.

Steps up to 108 in the processing in the processing sequence illustrated in FIG. 25 are identical to the steps in the processing in the processing sequence described with reference to FIG. 21.

Even in the case of this use example, a corresponding model having undergone learning for each combination of pieces of column data that are identical to each other in data type is evaluated, simultaneously to uploading of teacher data of correctness.

However, in the case of this use example, no result of the evaluation is presented to the user terminal 20 as an initial value.

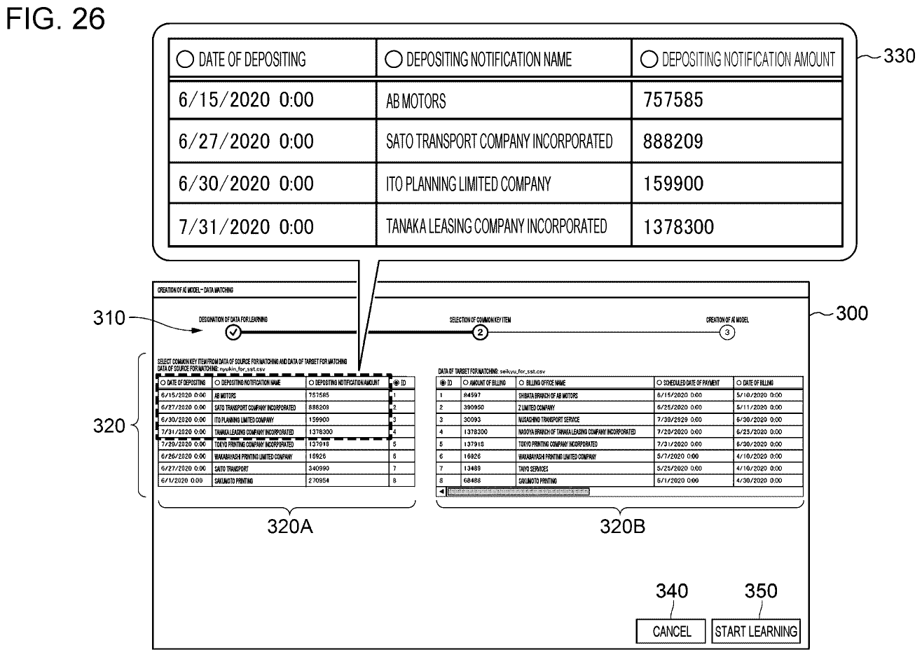

That is, upon completion of steps up to 108 in the processing, the business support server 10 presents a designation acceptance screen 300A for targets for matching (see FIG. 26) to the user terminal 20 (step 121).

FIG. 26 is a diagram illustrating a display example of the designation acceptance screen 300A for targets for matching, which is to be displayed on the user terminal 20. In FIG. 26, corresponding parts to those in FIG. 22 are denoted by identical reference signs.

The designation acceptance screen 300A for targets for matching is basically identical in layout to the designation acceptance screen 300 for targets for matching (see FIG. 22).

However, the designation acceptance screen 300A for targets for matching, which is illustrated in FIG. 26, differs from the designation acceptance screen 300 for targets for matching in that no candidate to be associated with each item is displayed as an initial value.

Therefore, as illustrated in a balloon 330, original table data serving a source for matching is displayed as is in the region 320A in the setting field 320 for a target of association, and original table data serving a target for matching is displayed as is in the region 320B.

Now back to the description of step 121 in FIG. 25.

In this use example, as the user terminal 20 accepts a display operation for a recommended item (step 122), the business support server 10 presents, as the recommended item, a combination that is high in score, among combinations with the designated item to the user terminal 20 (step 123).

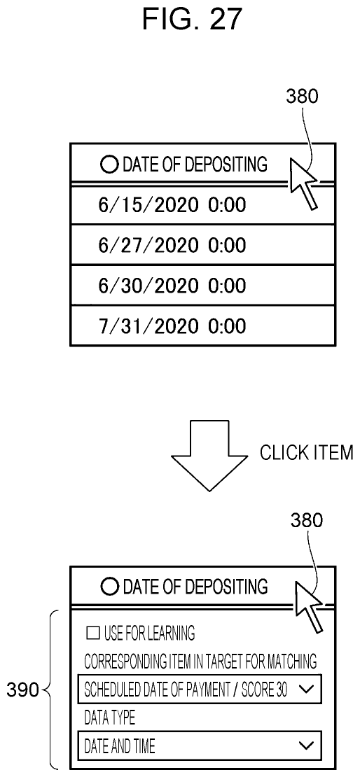

FIG. 27 is a diagram illustrating a change of screen, which corresponds to steps 122 and 123 (see FIG. 25).

In the case illustrated in FIG. 27, it is illustrated an example where a recommendation field 390 is displayed in a pull-down menu format as an item “Date of Depositing” is clicked with a mouse cursor 380. The clicking referred in here is an example of a predetermined call operation.

Content of information displayed in the recommendation field 390 is identical to content when displayed as an initial value.

In the case of this use example, the recommendation field 390 is displayed only when it is desired to know a recommendation value of a candidate of an explanatory variable for a target for matching to be combined with an explanatory variable for a source for matching. Therefore, it is possible to achieve switching of screen display in accordance with a skill level of the user operating the user terminal 20.

Note that steps in the processing after execution of step 123 (i.e., steps 110 to 112) are identical to the steps in the processing in Use Example 1 described above.

### <Use Example 3>

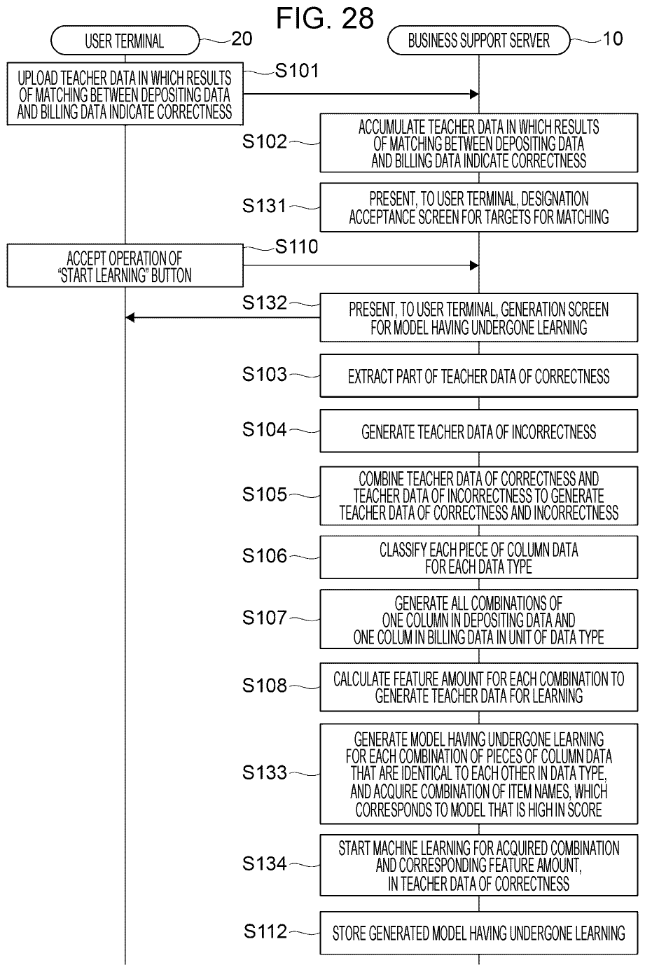

FIG. 28 is a sequence diagram illustrating still another example of providing the business support service. In FIG. 28, parts corresponding to those in FIG. 21 are denoted by identical reference signs.

Steps up to 102 in the processing in the processing sequence illustrated in FIG. 28 are identical to the steps in the processing in the processing sequence described with reference to FIG. 21. That is, the business support server 10 accumulates pieces of teacher data of correctness uploaded from the user terminal 20.

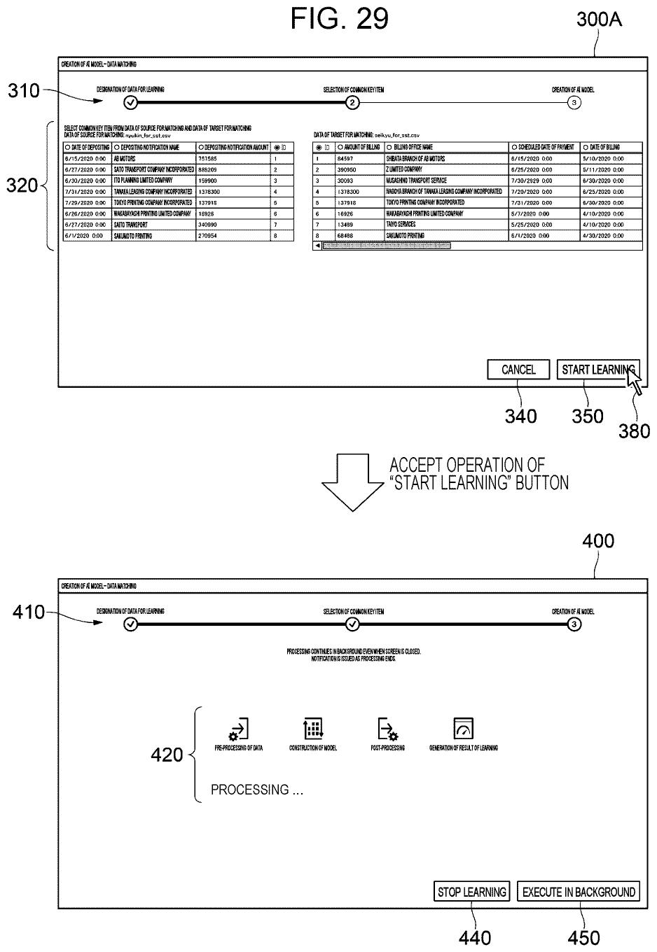

After that, the business support server 10 presents the designation acceptance screen 300A for targets for matching (see FIG. 26) to the user terminal (step 131). Upon acceptance of a designation, the business support server 10 presents a generation screen 400 for a model having undergone learning (see FIG. 29) to the user terminal 20 (step 132).

FIG. 29 is a diagram illustrating switching of screen along with a screen operation by the user. In FIG. 29, parts corresponding to those in FIG. 26 are denoted by identical reference signs.

As the user clicks the “Start Learning” button 350 on the designation acceptance screen 300A for targets for matching with the mouse cursor 380, screen switching occurs to the generation screen 400 for a model having undergone learning.

In the case illustrated in FIG. 29, the position of the current stage on the progress bar 410 has moved to the third stage.

Note that, to generate a model having undergone learning, all pieces of transaction data in the teacher data 13A1 of correctness (see FIG. 6) are used.

Therefore, in the generation screen 400 for a model having undergone learning, a presentation field 420 for a progress status is provided. In the case illustrated in FIG. 29, the progress status is managed in four stages. For example, the four stages include: “Pre-processing of Data”, “Construction of Model”, “Post-processing”, and “Generation of Result of Learning”. In FIG. 29, only “Pre-processing of Data” is displayed in an active state, while the other three stages are displayed in a grayed-out state. As the “Pre-processing of Data”, step 103 and subsequent steps described above are executed.

Note that, in the generation screen 400 for a model having undergone learning, a “Stop Learning” button 440 and an “Execute in Background” button 450 are provided.

Now back to the description with reference to FIG. 28.

After execution of step 132 described above, the business support server 10 sequentially executes steps 103 to 108 in the processing.

That is, upon acquisition of teacher data 13B for learning (see FIG. 2), the business support server 10 generates a model 13C having undergone learning (see FIG. 2) for each combination of pieces of column data that are identical to each other in data type, and acquires a combination of item names, which corresponds to a model that is high in score (step 133).

Next, the business support server 10 starts machine learning for the acquired combination and the corresponding feature amount, in teacher data 13A1 of correctness (see FIG. 6) (step 134).

After that, the business support server 10 stores a generated model having undergone learning (step 112).

### <Use Example 4>

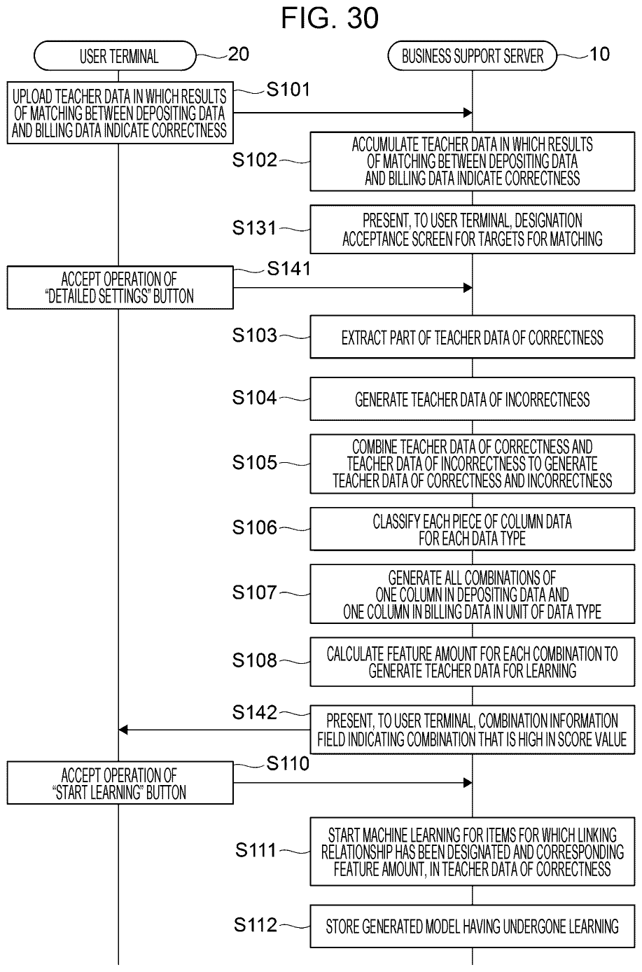

FIG. 30 is a sequence diagram illustrating still another example of providing the business support service. In FIG. 30, parts corresponding to those in FIG. 28 are denoted by identical reference signs.

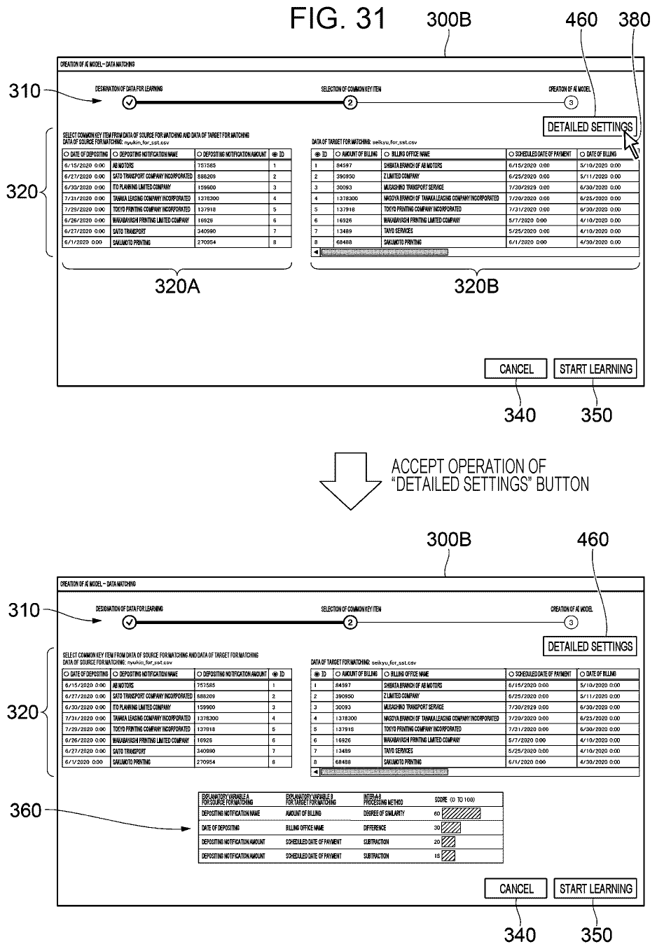

Steps up to 131 in the processing in the processing sequence illustrated in FIG. 30 are identical to the steps in the processing in the processing sequence described with reference to FIG. 28. That is, as the user uploads teacher data 13A1 of correctness (see FIG. 6), the business support server 10 causes the user device 20 to display a designation acceptance screen 300B for targets for matching (see FIG. 31).

On the other hand, the user terminal 20 accepts an operation on a “Detailed Settings” button 460 (see FIG. 31) (step 141). The “Detailed Settings” button 460 is provided on the designation acceptance screen 300B for targets for matching.

Upon acceptance of a notification of this operation, the business support server 10 sequentially executes steps 103 to 108 in the processing.

After that, the business support server 10 presents, to the user terminal 20, the combination information field 360 (see FIG. 23) indicating combinations that are high in score value (step 142).

After that, the user designates a combination of explanatory variables to be used in machine learning, with reference to the combination information field 360 that has been presented. Then, as content of the designation is determined, the user operates the “Start Learning” button 350 (see FIG. 23). That is, the user terminal 20 accepts an operation on the “Start Learning” button 350 (step 110).

Upon acceptance of a notification of the operation, the business support server 10 sequentially executes steps 111 to 112 in the processing.

FIG. 31 is a diagram illustrating a display example of the designation acceptance screen 300B for targets for matching. In FIG. 31, parts corresponding to those in FIG. 26 are denoted by identical reference signs.

The “Detailed Settings” button 460 is disposed at an upper right position on the designation acceptance screen 300B for targets for matching, which is illustrated in FIG. 31. In the case of this use example, the “Detailed Settings” button 460 serves as an execution start button for steps 103 to 108 described above.

Note that, when the “Start Learning” button 350 is operated without an operation of the “Detailed Settings” button 460, generation of a model having undergone learning starts in accordance with an association relationship designated by the user.

On the other hand, when the “Detailed Settings” button 460 is operated before an operation of the “Start Learning” button 350, the combination information field 360 appears on the designation acceptance screen 300B for targets for matching.

The combination information field 360 indicates a result of evaluation of a model having undergone learning for each combination, which has undergone learning in which a feature amount is designated to a combination of one piece of column data forming table data serving a source for matching, which is provided as the teacher data 13A1 of correctness, and one piece of column data forming table data serving as a target for matching. Therefore, the user is able to refer to the combination information field 360 that has been displayed to designate an explanatory variable for a target for matching, which is to be associated with an explanatory variable for a source for matching.

### <Summary>

With the business support server 10 (see FIG. 1) described above, it is possible to shorten a period of time required for pre-processing, compared with a case where an association relationship with which a degree of accuracy of prediction for correctness and incorrectness increases is verified for all data columns in two pieces of table data that differ from each other in format (for example, teacher data 13A1 of correctness (see FIG. 6)).

Furthermore, in the case of the business support server 10 described above, it is possible to support, even when the user is unfamiliar with a designation of an explanatory variable for machine learning, the user making a designation, similar to Use Example 1 (see FIGS. 22 to 24), Use Example 2 (see FIG. 27), and Use Example 4 (see FIG. 31), for example.

### Other Exemplary Embodiments

(1) Although the exemplary embodiment of the present disclosure has been described, the technical scope of the present disclosure is not limited to fall within the range of the exemplary embodiment described above. It is obvious that the technical scope of the present disclosure also includes those variously changed or modified from the exemplary embodiment described above.

(2) In the exemplary embodiment described above, it has been assumed that a model having undergone learning for supporting a deleting operation due to depositing of money be generated. However, a matching operation that is subject to the support is not limited to such a deleting operation. For example, the matching operation that is subject to the support may be a collation of bills, integration of pieces of customer data, and identification of names.

(3) Although, in the exemplary embodiment described above, teacher data 13A1 of correctness (see FIG. 6), which is uploaded by the user, is used as is, processing (so-called data cleansing) for performing conversion into a data format suitable for data processing may be executed before start of the data processing described above. For example, calendar information such as week days and holidays may be added in teacher data. Furthermore, for example, a missing part of teacher data may be complemented with a most frequent value. Furthermore, for example, a specific symbol included in a character string may be extracted to complement whether a corresponding numerical value is a negative numerical value or a positive numerical value. Furthermore, for example, an item such as a month may be created based on a date and time. Furthermore, for example, processing for integrating uppercase letters, lowercase letters, full-width letters, and half-width letters, for example, may be executed.

(4) Although, in the exemplary embodiment described above, a model having undergone learning is generated from teacher data 13B41 for learning (see FIG. 17), which corresponds to a combination of items for which data types belong to “Category”, no learning model may be generated for items for which data types belong to “Category”.

(5) In the exemplary embodiment described above, each processing is executed by a desired computer. Furthermore, the desired computer may include a processor serving as hardware, a program serving as software, or a combination of the processor and the program to execute the processing.

In this case, the processor is configured to perform the processes in the exemplary embodiments in cooperation with the program and may function as a unit or a means in the exemplary embodiments.

The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may include a programmable logic device such as a central processing unit (CPU), a micro processing unit (MPU), or a field programmable gate array (FPGA), a dedicated circuit for executing certain processing, such as an application specific integrated circuit (ASIC), and hardware such as a graphic processing unit (GPU) or a neural processing unit (NPU).

Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage).

The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

(5) The present disclosure is also applicable to a program and a program product.

### Appendix

(((1)))

An information processing system comprising a processor is configured to: accept, as a piece of teacher data, a piece of first table data and a piece of second table data between which results of matching indicate correctness; combine each of pieces of first column data in the piece of first table data and each of pieces of second column data in the piece of second table data, the each of the pieces of first column data and the each of the pieces of second column data being identical to each other in data type, to generate a piece of second teacher data; and use a model having undergone learning, the model being generated from the piece of second teacher data, to present candidates for associating each of the pieces of first column data and each of the pieces of second column data with each other.

(((2)))

The information processing system according to (((1))), wherein the processor is configured to: combine each of the pieces of first column data and each of the pieces of second column data, the each of the pieces of first column data and the each of the pieces of second column data being identical to each other in data type, with each other to generate a plurality of pieces of second teacher data; separately perform machine learning on each of the plurality of pieces of second teacher data to generate a plurality of learning models; and present the candidates for the pieces of first column data or the pieces of second column data based on a degree of accuracy of prediction for each of the plurality of learning models that has been generated.

(((3)))

The information processing system according to (((1))) or (((2))) wherein the processor is configured to present the candidates on a screen that prompts a user to designate a piece of column data in another one of the pieces of table data, the piece of column data being to be combined with either one of the pieces of first column data or one of the pieces of second column data in one of the pieces of table data.

(((4)))

The information processing system according to (((3))), wherein the processor is configured to present the candidates as initial values for the pieces of column data.

(((5)))

The information processing system according to (((3))), wherein the processor is configured to present the candidates in response to a predetermined call operation.

(((6)))

The information processing system according to (((3))), wherein the processor is configured to present a feature amount designating a parameter to be used for generating the model having undergone learning, in association with the candidates.

(((7)))

The information processing system according to (((6))), wherein, when the data type is numerical value, the feature amount is any one of four arithmetic operations.

(((8)))

The information processing system according to any one of (((1))) to (((7))), wherein the processor is configured to present a degree of accuracy of prediction calculated for each of the candidates.

(((9)))

The information processing system according to (((8))), wherein the processor is configured to present the corresponding degree of accuracy of prediction, when each of the candidates is to be presented in association with each of the pieces of first column data or each of the pieces of second column data.

(((10)))

The information processing system according to (((8))), wherein the processor is configured to present degrees of accuracy of prediction corresponding to the candidates in a list form.

(((11)))

The information processing system according to any one of (((1))) to (((10))), wherein the processor is configured to extract a part of the piece of teacher data to generate a piece of partial teacher data, and, when a piece of second partial teacher data in which a matching relationship indicates incorrectness is to be generated from the piece of partial teacher data that has been generated, combine each of the pieces of first column data in the piece of first table data and each of the pieces of second column data in the piece of second table data, the pieces of first table data and the pieces of second table data being included in the piece of second partial teacher data, the each of the pieces of first column data and the each of the pieces of second column data being identical to each other in data type, with each other to generate a piece of third partial teacher data, and generate a model having undergone learning from the piece of third partial teacher data.

(((12)))

The information processing system according to any one of (((1))) to (((11))), wherein the processor is configured to provide, to the model having undergone learning, a piece of third teacher data in which results of matching between pieces of first row data in the piece of first table data and pieces pf second row data in the piece of second table data indicate correctness and incorrectness to calculate a degree of accuracy of prediction.

(((13)))

A program causing a computer to execute a process comprising: accepting, as a piece of teacher data, a piece of first table data and a piece of second table data between which results of matching indicate correctness; combining each of pieces of first column data in the piece of first table data and each of pieces of second column data in the piece of second table data, the each of the pieces of first column data and the each of the pieces of second column data being identical to each other in data type, to generate a piece of second teacher data; and using a model having undergone learning, the model being generated from the piece of second teacher data, to present candidates for associating each of the pieces of first column data and each of the pieces of second column data with each other.

What is claimed is:

1. An information processing system comprising:
a processor configured to:
accept, as a piece of teacher data, a piece of first table data and a piece of second table data between which results of matching indicate correctness;
combine each of pieces of first column data in the piece of first table data and each of pieces of second column data in the piece of second table data, the each of the pieces of first column data and the each of the pieces of second column data being identical to each other in data type, to generate a piece of second teacher data; and
use a model having undergone learning, the model being generated from the piece of second teacher data, to present candidates for associating each of the pieces of first column data and each of the pieces of second column data with each other.

2. The information processing system according to claim 1, wherein the processor is configured to:
combine each of the pieces of first column data and each of the pieces of second column data, the each of the pieces of first column data and the each of the pieces of second column data being identical to each other in data type, with each other to generate a plurality of pieces of second teacher data;
separately perform machine learning on each of the plurality of pieces of second teacher data to generate a plurality of learning models; and
present the candidates for the pieces of first column data or the pieces of second column data based on a degree of accuracy of prediction for each of the plurality of learning models that has been generated.

3. The information processing system according to claim 1, wherein the processor is configured to:
present the candidates on a screen that prompts a user to designate a piece of column data in another one of the pieces of table data, the piece of column data being to be combined with either one of the pieces of first column data or one of the pieces of second column data in one of the pieces of table data.

4. The information processing system according to claim 3, wherein the processor is configured to:
present the candidates as initial values for the pieces of column data.

5. The information processing system according to claim 3, wherein the processor is configured to:
present the candidates in response to a predetermined call operation.

6. The information processing system according to claim 3, wherein the processor is configured to:
present a feature amount designating a parameter to be used for generating the model having undergone learning, in association with the candidates.

7. The information processing system according to claim 6, wherein, when the data type is numerical value, the feature amount is any one of four arithmetic operations.

8. The information processing system according to claim 1, wherein the processor is configured to:
present a degree of accuracy of prediction calculated for each of the candidates.

9. The information processing system according to claim 8, wherein the processor is configured to:
present the corresponding degree of accuracy of prediction, when each of the candidates is to be presented in association with each of the pieces of first column data or each of the pieces of second column data.

10. The information processing system according to claim 8, wherein the processor is configured to:
present degrees of accuracy of prediction corresponding to the candidates in a list form.

11. The information processing system according to claim 1, wherein the processor is configured to:
extract a part of the piece of teacher data to generate a piece of partial teacher data; and,
when a piece of second partial teacher data in which a matching relationship indicates incorrectness is to be generated from the piece of partial teacher data that has been generated,
combine each of the pieces of first column data in the piece of first table data and each of the pieces of second column data in the piece of second table data, the pieces of first table data and the pieces of second table data being included in the piece of second partial teacher data, the each of the pieces of first column data and the each of the pieces of second column data being identical to each other in data type, with each other to generate a piece of third partial teacher data; and
generate a model having undergone learning from the piece of third partial teacher data.

12. The information processing system according to claim 1, wherein the processor is configured to:
provide, to the model having undergone learning, a piece of third teacher data in which results of matching between pieces of first row data in the piece of first table data and pieces pf second row data in the piece of second table data indicate correctness and incorrectness to calculate a degree of accuracy of prediction.

13. A non-transitory computer readable medium storing a program causing a computer to execute a process comprising:
accepting, as a piece of teacher data, a piece of first table data and a piece of second table data between which results of matching indicate correctness;
combining each of pieces of first column data in the piece of first table data and each of pieces of second column data in the piece of second table data, the each of the pieces of first column data and the each of the pieces of second column data being identical to each other in data type, to generate a piece of second teacher data; and
using a model having undergone learning, the model being generated from the piece of second teacher data, to present candidates for associating each of the pieces of first column data and each of the pieces of second column data with each other.
